(19) United States
(12) Patent Application Publication
(10) Pub. No.: US 2026/0046669 A1
(43) Pub. Date: Feb. 12, 2026

(54) DATA COLLECTION AND REPORTING CONFIGURATIONS FOR NETWORK-BASED MODEL TRAINING

(71) Applicant: QUALCOMM Incorporated, San Diego, CA (US)

(72) Inventor: Rajeev KUMAR, San Diego, CA (US)

(21) Appl. No.: 19/291,329

(22) Filed: Aug. 5, 2025

Related U.S. Application Data
(60) Provisional application No. 63/679,912, filed on Aug. 6, 2024.

(51) Int. Cl. H04W 24/10; H04L 41/16

(52) U.S. Cl. CPC H04W 24/10; H04L 41/16

(57) ABSTRACT

Methods, systems, and devices for wireless communications are described. A first network entity (e.g., a user equipment (UE)) may receive configuration information to cause the first network entity to collect measurement information associated with network-based model training and to report a measurement report based on the measurement information where the measurement report may include the measurement information. Moreover, the configuration information may indicate one or more network identifiers that correspond to respective targets to which the first network entity is allowed to transmit the measurement report. Then, the first network entity may transmit the measurement report to the respective targets that correspond to the one or more network identifiers indicated within the configuration information. Further, the transmission of the measurement report to the respective targets may be based on an inclusion of the respective network identifiers associated with the respective targets in the configuration information.

### CROSS REFERENCES

The present Application for Patent claims benefit of U.S. Provisional Patent Application No. 63/679,912 by KUMAR et al., entitled “DATA COLLECTION AND REPORTING CONFIGURATIONS FOR NETWORK-BASED MODEL TRAINING,” filed Aug. 6, 2024, and assigned to the assignee hereof. U.S. Provisional Patent Application No. 63/679,912 is expressly incorporated herein by reference in its entirety.

### INTRODUCTION

The following relates to wireless communications, including data collection and reporting configurations for network-based model training.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be referred to as a user equipment (UE).

### SUMMARY

The systems, methods, and devices of this disclosure each have several innovative aspects, no single one of which is solely responsible for the desirable attributes disclosed herein.

A method for wireless communications by a first network entity is described. The method may include receiving configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information and transmitting the measurement report to the respective targets that correspond to the one or more network identifiers indicated within the configuration information, where transmission of the measurement report to the respective targets is based on inclusion of respective network identifiers associated with the respective targets in the configuration information.

A first network entity for wireless communications is described. The first network entity may include one or more memories storing processor executable code, and one or more processors coupled with the one or more memories. The one or more processors may individually or collectively be operable to execute the code to cause the first network entity to receive configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information and transmit the measurement report to the respective targets that correspond to the one or more network identifiers indicated within the configuration information, where transmission of the measurement report to the respective targets is based on inclusion of respective network identifiers associated with the respective targets in the configuration information.

Another first network entity for wireless communications is described. The first network entity may include means for receiving configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information and means for transmitting the measurement report to the respective targets that correspond to the one or more network identifiers indicated within the configuration information, where transmission of the measurement report to the respective targets is based on inclusion of respective network identifiers associated with the respective targets in the configuration information.

A non-transitory computer-readable medium storing code for wireless communications is described. The code may include instructions executable by one or more processors to receive configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information and transmit the measurement report to the respective targets that correspond to the one or more network identifiers indicated within the configuration information, where transmission of the measurement report to the respective targets is based on inclusion of respective network identifiers associated with the respective targets in the configuration information.

In some aspects of the method, first network entities, and non-transitory computer-readable medium described herein, where the one or more network identifiers include mobile network identifiers that correspond to respective mobile networks and where the respective targets include the respective mobile networks.

In some aspects of the method, first network entities, and non-transitory computer-readable medium described herein, where the one or more network identifiers include cell identifiers that correspond to respective cells and where the respective targets include the respective cells.

In some aspects of the method, first network entities, and non-transitory computer-readable medium described herein, where the configuration information indicates one or more identifiers for data collections for the network-based model training, and where the measurement information may be based on the one or more identifiers for the data collections.

In some aspects of the method, first network entities, and non-transitory computer-readable medium described herein, where the one or more identifiers for the data collections indicate at least one of a network entity configuration, a codebook index, an antenna tilt, or any combination thereof.

Some aspects of the method, first network entities, and non-transitory computer-readable medium described herein may further include operations, features, means, or instructions for receiving a request to collect the measurement information associated with the network-based model training based on inclusion of a respective identifier for the data collections in the configuration information.

In some aspects of the method, first network entities, and non-transitory computer-readable medium described herein, transmitting the measurement report may include operations, features, means, or instructions for transmitting the measurement report to the respective targets based on an indication of one or more measurement information collection sessions in the configuration information.

In some aspects of the method, first network entities, and non-transitory computer-readable medium described herein, transmitting the measurement report may include operations, features, means, or instructions for transmitting the measurement report to the respective targets based on an indication of one or more network entities in the configuration information, where the respective targets include the one or more network entities.

In some aspects of the method, first network entities, and non-transitory computer-readable medium described herein, the first network entity includes a memory accessible by a processing system and the method, apparatuses, and non-transitory computer-readable medium may include further operations, features, means, or instructions for storing the one or more network identifiers on the memory.

In some aspects of the method, first network entities, and non-transitory computer-readable medium described herein, transmitting the measurement report may include operations, features, means, or instructions for transmitting the measurement report to the respective targets via a low priority signaling radio bearer (SRB), where the low priority SRB may be enumerated as SRB4 or higher.

Some aspects of the method, first network entities, and non-transitory computer-readable medium described herein may further include operations, features, means, or instructions for transmitting, to the respective targets, an availability indication that indicates that measurements associated with the network-based model training may be available for transmission, where transmission of the availability indication to the respective targets may be based on inclusion of the one or more network identifiers associated with the respective targets in the configuration information and receiving, from a first target of the respective targets via a particular SRB of one or more SRBs, a request for the measurement report, where transmission of the measurement report to the first target via respective may be based on reception of the request.

In some aspects of the method, first network entities, and non-transitory computer-readable medium described herein, verifying, in response to reception of the request from the first target and prior to transmission of the measurement report, that the first target corresponds to a respective network identifier of the one or more network identifiers indicated in the configuration information, where transmission of the measurement report to the first target may be based on a verification of the first target.

In some aspects of the method, first network entities, and non-transitory computer-readable medium described herein, verifying, prior to transmission of the availability indication, that a respective target corresponds to a respective network identifier of the one or more network identifiers indicated in the configuration information, where transmission of the availability indication to the respective target may be based on a verification of the respective target.

In some aspects of the method, first network entities, and non-transitory computer-readable medium described herein, the measurement report includes a configuring network identifier associated with a data collection configuration, an identifier associated with data collection session for training that may be associated with the data collection configuration, and one or more other identifiers that may be associated with the data collection configuration.

In some aspects of the method, first network entities, and non-transitory computer-readable medium described herein, the measurement report includes a configuring network identifier associated with a network entity configuration, an identifier associated with data collection session for training that may be associated with the network entity configuration, and one or more other identifiers that may be associated with the network entity configuration.

A method for wireless communications by a first network entity is described. The method may include transmitting configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information and receiving, from the second network entity, the measurement report, where reception of the measurement report by the first network entity is based on inclusion of a respective network identifier associated with the first network entity in the configuration information.

A first network entity for wireless communications is described. The first network entity may include one or more memories storing processor executable code, and one or more processors coupled with the one or more memories. The one or more processors may individually or collectively be operable to execute the code to cause the first network entity to transmit configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information and receive, from the second network entity, the measurement report, where reception of the measurement report by the first network entity is based on inclusion of a respective network identifier associated with the first network entity in the configuration information.

Another first network entity for wireless communications is described. The first network entity may include means for transmitting configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information and means for receiving, from the second network entity, the measurement report, where reception of the measurement report by the first network entity is based on inclusion of a respective network identifier associated with the first network entity in the configuration information.

A non-transitory computer-readable medium storing code for wireless communications is described. The code may include instructions executable by one or more processors to transmit configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information and receive, from the second network entity, the measurement report, where reception of the measurement report by the first network entity is based on inclusion of a respective network identifier associated with the first network entity in the configuration information.

In some aspects of the method, first network entities, and non-transitory computer-readable medium described herein, where the one or more network identifiers include mobile network identifiers that correspond to respective mobile networks and where the respective targets include the respective mobile networks.

In some aspects of the method, first network entities, and non-transitory computer-readable medium described herein, where the one or more network identifiers include cell identifiers that correspond to respective cells and where the respective targets include the respective cells.

In some aspects of the method, first network entities, and non-transitory computer-readable medium described herein, where the configuration information indicates one or more identifiers for data collections for the network-based model training, and where the measurement information may be based on the one or more identifiers for the data collections.

In some aspects of the method, first network entities, and non-transitory computer-readable medium described herein, where the one or more identifiers for the data collections indicate at least one of a network entity configuration, a codebook index, an antenna tilt, or any combination thereof.

Some aspects of the method, first network entities, and non-transitory computer-readable medium described herein may further include operations, features, means, or instructions for transmitting, to the second network entity, a request to collect the measurement information associated with the network-based model training based on inclusion of a respective identifier for the data collections in the configuration information.

In some aspects of the method, first network entities, and non-transitory computer-readable medium described herein, receiving the measurement report may include operations, features, means, or instructions for receiving, from the second network entity, the measurement report based on an indication of one or more measurement information collection sessions in the configuration information.

In some aspects of the method, first network entities, and non-transitory computer-readable medium described herein, receiving the measurement report may include operations, features, means, or instructions for receiving, from the second network entity, the measurement report based on an indication of one or more network entities in the configuration information, where the respective targets include the one or more network entities, and where the one or more network entities includes the first network entity.

In some aspects of the method, first network entities, and non-transitory computer-readable medium described herein, receiving the measurement report may include operations, features, means, or instructions for receiving, from the second network entity, the measurement report via a low priority SRB, where the low priority SRB may be enumerated as SRB4 or higher.

Some aspects of the method, first network entities, and non-transitory computer-readable medium described herein may further include operations, features, means, or instructions for receiving, from the second network entity, an availability indication that indicates that measurements associated with the network-based model training may be available for transmission, where reception of the availability indication at the first network entity may be based on inclusion of the one or more network identifiers associated with first network entity in the configuration information and transmitting, to the second network entity via a particular SRB of one or more SRBs, a request for the measurement report, where reception of the measurement report from the second network entity via respective may be based on reception of the request.

In some aspects of the method, first network entities, and non-transitory computer-readable medium described herein, the measurement report includes a configuring network identifier associated with a data collection configuration, an identifier associated with data collection session for training that may be associated with the data collection configuration, and one or more other identifiers that may be associated with the data collection configuration.

In some aspects of the method, first network entities, and non-transitory computer-readable medium described herein, the measurement report includes a configuring network identifier associated with a network entity configuration, an identifier associated with data collection session for training that may be associated with the network entity configuration, and one or more other identifiers that may be associated with the network entity configuration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports data collection and reporting configurations for network-based model training in accordance with one or more aspects of the present disclosure.

FIG. 2 shows an illustrative block diagram of an example machine learning (ML) model that supports data collection and reporting configurations for network-based model training in accordance with one or more aspects of the present disclosure.

FIGS. 3 and 4 show an illustrative block diagram of an example ML architecture that supports data collection and reporting configurations for network-based model training in accordance with one or more aspects of the present disclosure.

FIG. 5 shows an example of a wireless communications system that supports data collection and reporting configurations for network-based model training in accordance with one or more aspects of the present disclosure.

FIG. 6 shows an example of a process flow that supports data collection and reporting configurations for network-based model training in accordance with one or more aspects of the present disclosure.

FIGS. 7 and 8 show block diagrams of devices that support data collection and reporting configurations for network-based model training in accordance with one or more aspects of the present disclosure.

FIG. 9 shows a block diagram of a communications manager that supports data collection and reporting configurations for network-based model training in accordance with one or more aspects of the present disclosure.

FIG. 10 shows a diagram of a system including a device that supports data collection and reporting configurations for network-based model training in accordance with one or more aspects of the present disclosure.

FIGS. 11 and 12 show block diagrams of devices that support data collection and reporting configurations for network-based model training in accordance with one or more aspects of the present disclosure.

FIG. 13 shows a block diagram of a communications manager that supports data collection and reporting configurations for network-based model training in accordance with one or more aspects of the present disclosure.

FIG. 14 shows a diagram of a system including a device that supports data collection and reporting configurations for network-based model training in accordance with one or more aspects of the present disclosure.

FIGS. 15 and 16 show flowcharts illustrating methods that support data collection and reporting configurations for network-based model training in accordance with one or more aspects of the present disclosure.

### DETAILED DESCRIPTION

In some wireless communication systems, wireless devices may use artificial intelligence (AI) and machine learning (ML) models (e.g., referred to as AI/ML models) for beam predictions. In some aspects, a user equipment (UE) may perform one or more measurements to collect a set of measurement data that a network entity can use to train AI/ML models. Further, the UE may report the measurement data to a network entity in a measurement report such that the network entity can use the measurement data for network-based model training. For example, the network entity may use the measurement data to train one or more AI/ML models for use by the network entity, the UE, or both to generate a set of beam predictions for a set of downlink beams based on measurement data from another set of downlink beams (e.g., current, or historical beam measurements).

In some cases, when reporting the measurement data for the network-based model training, the UE may transmit a measurement report that includes the measurement data to the network entity directly after performing the measurements to collect the measurement data. Moreover, the UE may transmit the measurement report to the network entity via a high priority signaling radio bearer (SRB) such as SRB1 or SRB3. In some other cases, the UE may log the measurement data and wait until the UE has a relatively large quantity of measurement data stored to transmit the measurement report to the network entity via an SRB such as SRB1 or SRB3. However, when transmitting the logged measurement data, the size of the measurement report may be relatively large resulting in blockage on the SRB1. Further, when transmitting a measurement report immediately after collecting the measurement data for the measurement report, the transmission of the measurement report may result in sudden signaling overhead on the SRB1 or SRB3. Additionally, or alternatively, if a UE experiences a link failure or enters an idle state and the UE has measurement data stored (e.g., logged at the UE), once the UE reestablishes communications, the UE may be unaware of where to transmit the logged measurement data. Moreover, when transmitting a measurement report, a UE may refrain from checking network identifiers. For example, the UE may transmit a measurement report to a network entity that the measurement report is unintended for, thus resulting in leakage of information from one infra-vendor to another, or from one mobile network (e.g., a public land mobile network (PLMN)) to another mobile network.

To prevent head-of-line blockage or an increase in signaling overhead on high priority SRBs (e.g., SRB1, SRB3), the techniques of the present disclosure may enable UEs and network entities to improve the transfer of collected training data, provide configuration enhancements, provide reporting mechanism enhancements, and provide inter-node signaling enhancements. For example, a network entity may configure a UE with information that configures the UE to collect measurement information associated with network-based model training and to report a measurement report based on the measurement information. The configuration information may also indicate one or more network identifiers that correspond to respective targets (e.g., cells, PLMNs, radio access network (RAN) notification areas, tracking areas, network entities, or any combination thereof) that the UE is allowed to transmit a measurement report to that includes measurement data for the network-based model training. Further, the network entity may configure the UE to transmit the measurement reports on a lower priority SRB. In some examples, the configuration information may also enable the UE to transmit an availability indication to a network entity. The availability indication may indicate that the UE has measurement information that has been collected and logged and is ready to report. The network entity may, in response to receiving the availability indication, transmit a request for the measurement report and the UE may transmit the measurement report accordingly.

Additionally, or alternatively, the network entity may configure the UE to check network identifiers indicated within the configuration information before transmitting information to ensure that the correct network identifiers receive the respective information. Further, such techniques may enable a network entity to train AI/ML models for a network entity, for a UE, or both (e.g., independent AI/ML models for network entities and UEs or a single AI/ML model for both a network entity and a UE). Thus, the techniques of the present disclosure may enable a UE to collect and log measurement data and transmit the measurement data within a measurement report to respective network entities more efficiently to reduce latency and improve communications in a wireless communications system.

Aspects of the disclosure are initially described in the context of wireless communications systems. Additional aspects of the disclosure are described with reference to a wireless communications system and a process flow. Aspects of the disclosure are further illustrated by and described with reference to apparatus diagrams, system diagrams, and flowcharts that relate to data collection and reporting configurations for network-based model training.

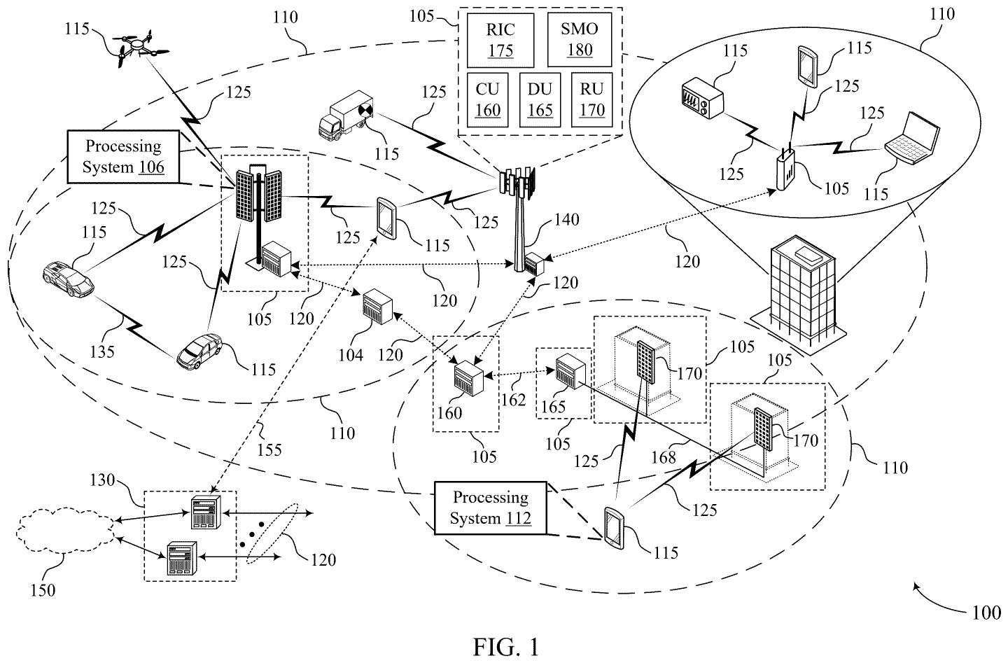

FIG. 1 shows an example of a wireless communications system 100 that supports data collection and reporting configurations for network-based model training in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a RAN node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other aspects or various combinations thereof. A UE 115 may communicate with the core network 130 via a communication link 155.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other aspects. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other aspects, which may be implemented in various objects such as appliances, vehicles, or meters, among other aspects.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other aspects, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other aspects.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other aspects, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is referred to as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other aspects.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some aspects, a device may support same-slot HARQ feedback, in which case the device may provide HARQ feedback in a specific slot for data received via a previous symbol in the slot. In some other aspects, the device may provide HARQ feedback in a subsequent slot, or according to some other time interval.

Certain aspects and techniques as described herein may be implemented, at least in part, using an AI program, such as a program that includes a ML or artificial neural network (ANN) model. An aspect ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An aspect ML model operating on input data may start at an initial output based on the biases and then update its output based on a combination of the input data and the weights.

In some aspects, an ML model may be configured to provide computing capabilities for wireless communications. Such an ML model may be configured with weights and biases to perform beam predictions for a set of downlink beams to improve beam management. Thus, during operation of a device, the ML model may receive input data (such as beam measurements, wireless device measurements, and the like) and make inferences (such as beam predictions) based on the weights and biases.

ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some aspects, how one or more tasks or problems in wireless communications may benefit from the application of one or more ML models to generate beam predictions for a set of beams to improve beam management. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In some aspects, a UE 115 may perform one or more measurements to collect a set of measurement data that can be used to train AI/ML models. Further, the UE 115 may report the measurement data to a network entity 105 in a measurement report such that the measurement data can be used for network-based model training. For example, the network entity 105 may use the measurement data to train one or more AI/ML models for use by the network entity 105, the UE 115, or both to generate a set of beam predictions for a set of downlink beams based on measurement data from another set of downlink beams (e.g., current or historical beam measurements).

To prevent head-of-line blockage or an increase in signaling overhead on high priority SRBs (e.g., SRB1), the techniques of the present disclosure may enable UEs 115 and network entities 105 to improve the transfer of collected training data, provide configuration enhancements, provide reporting mechanism enhancements, and provide inter-node signaling enhancements. For example, a network entity 105 may configure a UE 115 with information that configures the UE 115 to collect measurement information associated with network-based model training and to report a measurement report based on the measurement information. The configuration information may also indicate one or more network identifiers that correspond to respective targets (e.g., cells, PLMNs, network entities, or any combination thereof) that the UE 115 is allowed to transmit a measurement report to that includes measurement data for the network-based model training. Further, the network entity 105 may configure the UE 115 to transmit the measurement reports on a lower priority SRB. In some examples, the configuration information may also enable the UE 115 to transmit an availability indication to a network entity 105. The availability indication may indicate that the UE 115 has measurement information that has been collected and logged and is ready to report. The network entity 105 may, in response to receiving the availability indication, transmit a request for the measurement report and the UE 115 may transmit the measurement report accordingly. Additionally, or alternatively, the network entity 105 may configure the UE 115 to check network identifiers indicated within the configuration information before transmitting information to ensure that the correct network identifiers receive the respective information. Thus, the techniques of the present disclosure may enable a UE 115 to collect and log measurement data and transmit the measurement data within a measurement report to respective network entities 105 more efficiently to reduce latency and improve communications in a wireless communications system.

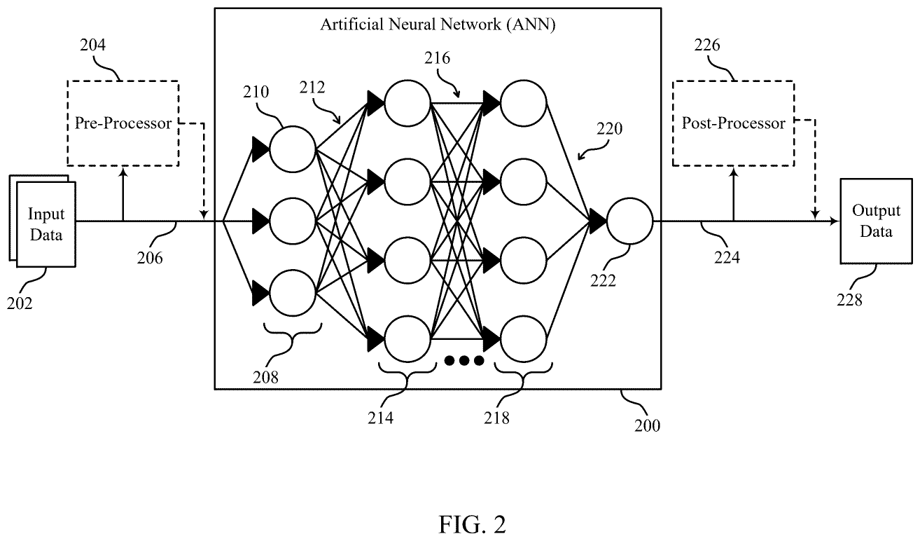

FIG. 2 shows an illustrative block diagram of an example ML model represented by an ANN 200 that supports data collection and reporting configurations for network-based model training in accordance with one or more aspects of the present disclosure.

ANN 200 may receive input data 206 which may include one or more bits of data A02, pre-processed data output from pre-processor 204 (optional), or some combination thereof. Here, data 202 may include training data, verification data, application-related data, or the like, based, for example, on the stage of deployment of ANN 200. Pre-processor 204 may be included within ANN 200 in some other implementations. Pre-processor 204 may, for example, process all or a portion of data 202 which may result in some of data 202 being changed, replaced, deleted, etc. In some implementations, pre-processor 204 may add additional data to data 202. In some implementations, the pre-processor 204 may be a ML model, such as an ANN. For example, a UE 115 may perform collect measurement data for network-based model training and transmit a measurement report to one or more configured network identifiers in accordance with the techniques of the present disclosure. Moreover, a network entity 105 may use the pre-processor 204 to process the data 202 (e.g., the measurement data from a UE 115) included in the measurement report to perform network-based model training.

ANN 200 includes at least one first layer 208 of artificial neurons 210 to process input data 206 and provide resulting first layer data via connections or “edges” such as edges 212 to at least a portion of at least one second layer 214. Second layer 214 processes data received via edges 212 and provides second layer output data via edges 216 to at least a portion of at least one third layer 218. Third layer 218 processes data received via edges 216 and provides third layer output data via edges 220 to at least a portion of a final layer 222 including one or more neurons to provide output data 224. All or part of output data 224 may be further processed in some manner by (optional) post-processor 226. Thus, in certain aspects, ANN 200 may provide output data 228 that is based on output data 224, post-processed data output from post-processor 226, or some combination thereof.

Post-processor 226 may be included within ANN 200 in some other implementations. Post-processor 226 may, for example, process all or a portion of output data 224 which may result in output data 228 being different, at least in part, to output data 224, as result of data being changed, replaced, deleted, etc. In some implementations, post-processor 226 may be configured to add additional data to output data 224. In this example, second layer 214 and third layer 218 represent intermediate or hidden layers that may be arranged in a hierarchical or other like structure. Although not explicitly shown, there may be one or more further intermediate layers between the second layer 214 and the third layer 218. In some implementations, the post-processor 226 may be a ML model, such as an ANN. Further, in some aspects, a network entity 105 may implement the post-processor for one or more models trained at the network entity 105. In some cases, based on receiving a measurement report from a UE 115, the network entity 105 may implement the post-processor 226 for training beam prediction models for the network entity 105 or for a UE 115.

The structure and training of artificial neurons 210 in the various layers may be tailored to specific requirements of an application. Within a given layer such as first layer 208, second layer 214, or third layer 218 of ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 200. The weights and biases of ANN 200 may be adjusted during a training process or during operation of ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 200, may be conducted using training data. Training data may include one or more datasets which ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may be repeated multiple times to fine-tune ANN 200 with each iteration.

ANN 200 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed

In example aspects, an ML model may be trained prior to, or at some point following, operation of the ML model, such as ANN 200, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). In another example, training data may be generated or collected online, offline, or both online and offline by a UE, network entity, or other device(s), and all or part of such training data may be transferred or shared (in real or near-real time), such as through store and forward functions or the like. For example, in accordance with the techniques of the present disclosure, a UE 115 may collet measurement data for network-based model training and then transmit a measurement report that includes the measurement data to a network entity 105 based on a network identifier associated with the network entity 105 being included within a set of network identifiers configured at the UE 115 that the UE 115 is allowed to transmit measurement reports to.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some aspects, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

In some aspects, a UE 115 may perform one or more measurements to collect a set of measurement data that can be used to train AI/ML models such as the ANN 200. Further, the UE 115 may report the measurement data to a network entity 105 in a measurement report such that the measurement data can be used for network-based model training (e.g., ANN 200 training). For example, the network entity 105 may use the measurement data to train an ANN 200 for use by the network entity 105, the UE 115, or both to generate a set of beam predictions for a set of downlink beams based on measurement data from another set of downlink beams (e.g., current or historical beam measurements).

To prevent blockage or an increase in signaling overhead on high priority SRBs (e.g., SRB1), the techniques of the present disclosure may enable UEs 115 and network entities 105 to improve the transfer of collected training data, provide configuration enhancements, provide reporting mechanism enhancements, and provide inter-node signaling enhancements. For example, a network entity 105 may configure a UE 115 with information that configures the UE 115 to collect measurement information associated with network-based model training and to report a measurement report based on the measurement information. The configuration information may also indicate one or more network identifiers that correspond to respective targets (e.g., cells, PLMNs, network entities, or any combination thereof) that the UE 115 is allowed to transmit a measurement report to that includes measurement data for the network-based model training. Further, the network entity 105 may configure the UE 115 to transmit the measurement reports on a lower priority SRB. In some examples, the configuration information may also enable the UE 115 to transmit an availability indication to a network entity 105. The availability indication may indicate that the UE 115 has measurement information that has been collected and logged and is ready to report. The network entity 105 may, in response to receiving the availability indication, transmit a request for the measurement report and the UE 115 may transmit the measurement report accordingly. Additionally, or alternatively, the network entity 105 may configure the UE 115 to check network identifiers indicated within the configuration information before transmitting information to ensure that the correct network identifiers receive the respective information. Thus, the techniques of the present disclosure may enable a UE 115 to collect and log measurement data and transmit the measurement data within a measurement report to respective network entities 105 more efficiently train a respective ANN 200.

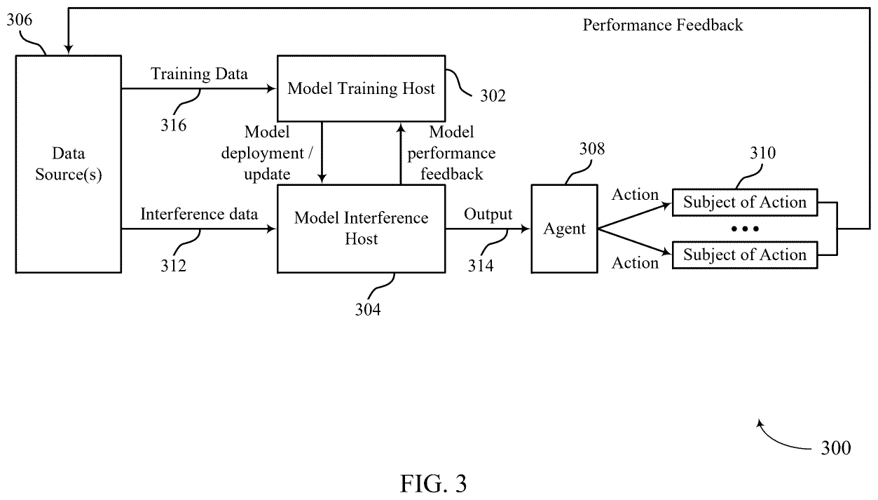

FIG. 3 shows an illustrative block diagram of an example ML architecture 300 that supports data collection and reporting configurations for network-based model training in accordance with one or more aspects of the present disclosure. In some examples, the ML architecture 300 that may be used for wireless communications in any of the various implementations, processes, environments, networks, or use cases listed above. As illustrated, architecture 300 includes multiple logical entities, such as model training host 302, model inference host 304, data source(s) 306, and agent 308. Model inference host 304 is configured to run an ML model based on inference data 312 provided by data source(s) 306. Model inference host 304 may produce output 314, which may include a prediction or inference, such as a discrete or continuous value based on inference data 312, which may then be provided as input to the agent 308.

Agent 308 may represent an element or an entity of a wireless communication system including, for example, a radio access network (RAN), a wireless local area network, a device-to-device (D2D) communications system, etc. As an example, agent 308 may be a UE 115 as described with reference to FIG. 1, a base station, a network entity 105 as described with reference to FIG. 1, or a disaggregated network entity (such as a centralized unit (CU), a distributed unit (DU), or a radio unit (RU)), an access point, a wireless station, a RAN intelligent controller (RIC) in a cloud-based RAN, among some examples. Additionally, agent 308 also may be a type of agent that depends on the type of tasks performed by model inference host 304, the type of inference data 312 provided to model inference host 304, or the type of output 314 produced by model inference host 304. For example, if output 314 from model inference host 304 is associated with beam management, agent 308 may be or include a UE 115, a network entity 105, or both. As another example, if output 314 from model inference host 304 is associated with transmission or reception scheduling, agent 308 may be a CU or a DU of a respective network entity 105.

Agent 308 may perform one or more actions associated with receiving output 314 from model inference host 304. For example, if agent 308 is a network entity 105 and the output from model inference host 304 is associated with beam management, agent 308 may determine whether to change or modify a transmit or receive beam based on output 314. Agent 308 may indicate the one or more actions performed to at least one subject of action 310. For example, model inference host 304 may predict channel characteristics for a set of beam based on the measurements of another set of beams. Based on the predicted channel characteristics, agent 308, the UE, may send, to the BS, a request to switch to a different beam for communications. In some cases, agent 308 and the subject of action 310 are the same entity.

Data can be collected from data sources 306, and may be used as training data 316 for training an ML model, or as inference data 312 for feeding an ML model inference operation. Data sources 306 may collect data from various subject of action 310 entities (such as, the UE 115), and provide the collected data to a model training host 302 for ML model training. In some aspects, if output 314 provided to agent 308 is inaccurate (or the accuracy is below an accuracy threshold), model training host 302 may provide feedback to model inference host 304 to modify or retrain the ML model used by model inference host 304, such as via an ML model deployment update.

Model training host 302 may be deployed at the same or a different entity than that in which model inference host 304 is deployed. For example, in order to offload model training processing, which can impact the performance of model inference host 304, model training host 302 may be deployed at a model server.

In some aspects, an ML model is deployed at or on a network entity 105 for network-based model training to predict beams for subsequent communications. More specifically, a model interference host, such as model inference host 304 in FIG. 3, may be deployed at or on the network entity 105 for enhancing Uu interfaces, Xn interfaces, NG-AP interfaces, or any combination thereof based on receiving measurement data within a measurement report from a UE 115.

In some aspects, a UE 115 may be an example of a source 306 that can perform one or more measurements to collect a set of training data 316 that can be used to train AI/ML models. Further, the UE 115 may report the measurement data (e.g., the training data 316) to a network entity 105 in a measurement report such that the measurement data can be used for network-based model training. In some aspects, the network entity 105 may be an example of an agent 308 and host both the model training host 302 and the model inference host 304. Moreover, the network entity 105 may use the measurement data to train one or more AI/ML models for use by the network entity 105, the UE 115, or both to perform a respective action 310 such as to generate a set of beam predictions for a set of downlink beams based on measurement data from another set of downlink beams (e.g., current or historical beam measurements).

To prevent blockage or an increase in signaling overhead on high priority SRBs (e.g., SRB1), the techniques of the present disclosure may enable UEs 115 and network entities 105 to improve the transfer of collected training data 316, provide configuration enhancements, provide reporting mechanism enhancements, and provide inter-node signaling enhancements. For example, a network entity 105 may configure a UE 115 with information that configures the UE 115 to collect measurement information (e.g., training data 316) associated with network-based model training and to report a measurement report based on the measurement information. The configuration information may also indicate one or more network identifiers that correspond to respective targets (e.g., cells, PLMNs, network entities, or any combination thereof) that the UE 115 is allowed to transmit a measurement report to that includes measurement data for the network-based model training. Further, the network entity 105 may configure the UE 115 to transmit the measurement reports on a lower priority SRB. In some examples, the configuration information may also enable the UE 115 to transmit an availability indication to a network entity 105. The availability indication may indicate that the UE 115 has measurement information that has been collected and logged and is ready to report. The network entity 105 may, in response to receiving the availability indication, transmit a request for the measurement report and the UE 115 may transmit the measurement report accordingly. Additionally, or alternatively, the network entity 105 may configure the UE 115 to check network identifiers indicated within the configuration information before transmitting information to ensure that the correct network identifiers receive the respective information. Thus, the techniques of the present disclosure may enable a UE 115 to collect and log measurement data and transmit the measurement data within a measurement report to respective network entities 105 more efficiently train a ML model at a model training host 302 for an agent 308 to perform actions (e.g., generate beam predictions).

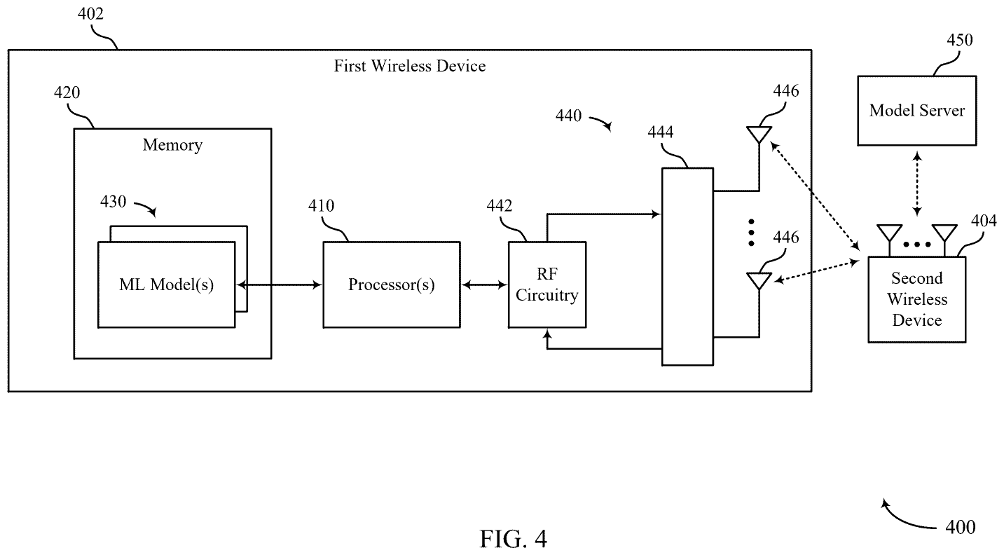

FIG. 4 shows an illustrative block diagram of an example ML architecture 400 that supports data collection and reporting configurations for network-based model training in accordance with one or more aspects of the present disclosure. In some examples, the ML architecture 400 of first wireless device 402 may be in communication with second wireless device 404. First wireless device 402 may be configured for training ML models for the first wireless device 402, a second wireless device 404, or both. Similarly, the second wireless device may be configured for collecting, logging, and reporting measurement data for network-based model training. Note that the example ML architecture of first wireless device 402 may be applied to second wireless device 404, and vice versa.

First wireless device 402 may be, or may include, a chip, system on chip (SoC), chipset, package or device that includes one or more processors, processing blocks or processing elements (collectively “processor 410”) and one or more memory blocks or elements (collectively “memory 420”). Processor 410 may be coupled to transceivers of the first wireless device 440, which includes radio frequency (RF) circuitry 442 coupled to antennas 446 via interface 444, for transmitting or receiving signals.

One or more ML models 430 (collectively “ML model 430”) may be stored in memory 420 and accessible to processor(s) 410. Individual or groups of ML models 430 may be associated with respective model identifiers. In some aspects, different ML models 430, which may optionally be associated with different model identifiers, may have different characteristics. One or more ML models 430 may be selected based on respective features, characteristics, or applications, as well as characteristics or conditions of first wireless device 440 (such as, a power state, a mobility state, a battery reserve, a temperature, etc.). For example, ML models 430 may have different inference data and output pairings (such as, different types of inference data produce different types of output), different levels of accuracies associated with the predictions, different latencies associated with producing the predictions, different ML model sizes, different coefficients, different parameters, etc.

Processor 410 may deploy ML models 430 to produce respective output data based on input data. For example, the processor 410 may receive a measurement report that includes measurement data from a UE 115 for network-based model training. In some aspects, model server 450 may perform various ML management tasks for first wireless device 402 and/or second wireless device 404. For example, model server 450 may operate as a model training host (such as model training host 302) and update ML model 430 using training data. In some cases, the model server 450 may operate as a data source (such as data source 306) to collect and host training data, inference data, performance feedback, etc., associated with ML model 430. In some other cases, the training data may be collected, stored, and then transmitted to the model training host 302 (e.g., a network entity 105) via a UE 115.

In some aspects, a UE 115 (e.g., the second wireless device 404) may perform one or more measurements to collect a set of measurement data that can be used to train AI/ML models (e.g., a ML model 430). Further, the UE 115 may report the measurement data to a network entity 105 (e.g., the first wireless device 402) in a measurement report such that the measurement data can be used for network-based model training. For example, the network entity 105 may use the measurement data to train one or more AI/ML models for use by the network entity 105, the UE 115, or both to generate a set of beam predictions for a set of downlink beams based on measurement data from another set of downlink beams (e.g., current or historical beam measurements).

To prevent head-of-line blockage or an increase in signaling overhead on high priority SRBs (e.g., SRB1), the techniques of the present disclosure may enable UEs 115 and network entities 105 to improve the transfer of collected training data, provide configuration enhancements, provide reporting mechanism enhancements, and provide inter-node signaling enhancements. For example, a network entity 105 may configure a UE 115 with information that configures the UE 115 to collect measurement information associated with network-based model training and to report a measurement report based on the measurement information. The configuration information may also indicate one or more network identifiers that correspond to respective targets (e.g., cells, PLMNs, network entities, or any combination thereof) that the UE 115 is allowed to transmit a measurement report to that includes measurement data for the network-based model training. Further, the network entity 105 may configure the UE 115 to transmit the measurement reports on a lower priority SRB. In some examples, the configuration information may also enable the UE 115 to transmit an availability indication to a network entity 105. The availability indication may indicate that the UE 115 has measurement information that has been collected and logged and is ready to report. The network entity 105 may, in response to receiving the availability indication, transmit a request for the measurement report and the UE 115 may transmit the measurement report accordingly. Additionally, or alternatively, the network entity 105 may configure the UE 115 to check network identifiers indicated within the configuration information before transmitting information to ensure that the correct network identifiers receive the respective information. Thus, the techniques of the present disclosure may enable a UE 115 to collect and log measurement data and transmit the measurement data within a measurement report to respective network entities 105 to train ML models 430 more efficiently and reliably at a first wireless device 402 (e.g., a network entity 105).

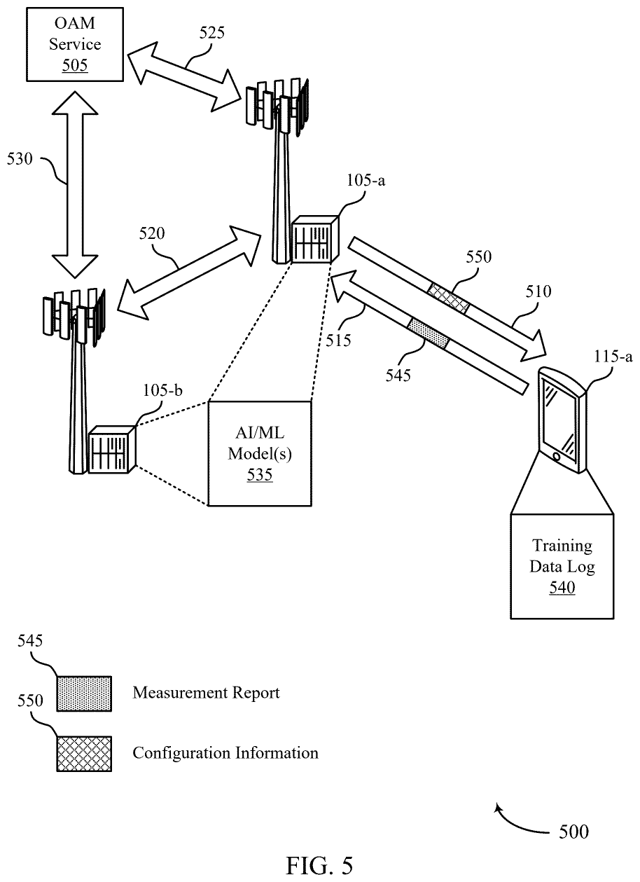

FIG. 5 shows an example of a wireless communications system 500 that supports data collection and reporting configurations for network-based model training in accordance with one or more aspects of the present disclosure. In some examples, the wireless communications system 500 may implement or be implemented by the wireless communications system 100. For example, the wireless communications system 500 may include a network entity 105-a, a network entity 105-b, a UE 115-a, and an OAM service 505, which may be examples of devices described herein with reference to FIG. 1. In some aspects, the network entity 105-a may communicate with the UE 115-a via a downlink communication link 510 and the UE 115-a may communicate with the network entity 105-a via an uplink communication link 515, which may be examples of a communication link 125 described herein with reference to FIG. 1. Further, the network entity 105-a may communicate with the network entity 105-b via a communication link 520 and the OAM service 505 via a communication link 525 respectively and the network entity 105-b may communicate with the OAM service 505 via a communication link 530. In some cases, the downlink communication link 510, the uplink communication link 515, the communication link 520, the communication link 525, and the communication link 520 may be examples of a Uu link, a sidelink, a backhaul link, a D2D link, an NG-AP link, an Xn link, or some other type of communication link 125 described herein with reference to FIG. 1.

In some aspects, as described elsewhere herein, the network entity 105-a, the network entity 105-b, or both, may train AI/ML models 535 for spatial and temporal downlink beam predictions. For spatial downlink beams, the AI/ML models 535 may generate spatial downlink beam predictions for a first set of beams (e.g., set-A beams) based on measurement results of a second set of beams (e.g., set-B beams). In some cases, if the second set of beams are wide beams (e.g., SSB beams), the first set of beams that the AI/ML models 535 generate predictions for may be narrow beams (e.g., CSI-RS beams). In some other cases, if the second set of beams are narrow beams, the first set of beams that the AI/ML models 535 generate predictions for may be other narrow beams. For temporal downlink beams, the AI/ML models 535 may generate temporal downlink beam predictions for a first set of beams based on historic measurement results of a second set of beams. In some cases, the first set of beams and the second set of beams may be the same resulting in pure temporal beam predictions from the AI/ML models 535. In some other cases, the first set of beams and the second set of beams may be different resulting in spatial and temporal beam predictions from the AI/ML models 535. Moreover, in some cases, an identifier (e.g., an associated identifier) may be provided to respective AI/ML models 535 to achieve consistency between training and inference. Additionally, or alternatively, while illustrated as being associated with the network entity 105-a and the network entity 105-b, in accordance with the techniques of the present disclosure, the AI/ML models 535 may be trained at a network entity 105 and both network entities 105 and UEs 115 (e.g., the UE 115-a) may be capable of using the AI/ML models 535 to generate the beam predictions in single-cell scenarios.

In some cases, for network-based data collection for beam management use cases, both a network entity 105 centric and an OAM service 505 centric approach may be utilized. Further the same measurement framework may be applied to data collections that are centric to both a network entity 105 and the OAM service 505 centric data collection for network-based data collections. In some other cases, for network entity 105 or OAM service 505 centric signaling (e.g., for RRC signaling between a UE 115 and a network entity 105), a UE 115 may report multiple instances of a level 1 (L1) measurement report to a network entity 105 via an RRC message as configured by the network entity 105. However, in some aspects, a single RRC message may be insufficient. Moreover, immediate minimization of drive test (MDT) (e.g., operations that enable network entities 105 to use UEs 115 for data collection) may be the baseline framework for OAM-centric data collection for training network-based models. However, the immediate MDT framework may be unable to support periodic reporting without additional enhancements.

As described herein, in some cases, the UE 115-a may collect measurement information (e.g., training data) and store the measurement information within a training data log 540 for transmission of a measurement report 545 that includes the measurement information stored within the training data log 540. In some other cases, the UE 115-a may transmit the measurement report 545 immediately after collecting the measurement information. In such cases, the UE 115-a may transmit the measurement report 545 via a high priority SRB such as SRB1. In some aspects, when transmitting the measurement report 545 immediately after a measurement the measurement report 545 may be relatively small. For example, the measurement report 545 may include a single measurement sample. In some other aspects, when transmitting measurement information (e.g., training data) that is within the training data log 540 in the measurement report 545 (e.g., a level 3 (L3) report), the size of the measurement report 545 may be relatively large. Moreover, in some cases, having the size of the measurement report 545 be relatively larger may result in head-of-line blockage on the SRB1. For example, the size of the measurement report 545 may prevent other messages or data packets from being transmitted on the SRB1 resulting in an increase in latency on a high priority SRB which can further result in a decrease in efficiency and reliability of the wireless communications system 500.

Additionally, or alternatively, wireless devices (e.g., network entities 105) within the wireless communications system 500 may lack a request-based mechanism for requesting and receiving a measurement report 545 from other wireless devices (e.g., UEs 115). Thus, due to the lack of a request mechanism wireless devices may experience undesired and sudden increases in signaling overhead on the SRB1 that can result in an increase in latency for high priority data packets. Moreover, transmissions of relatively large data packets (e.g., when the measurement report 545 includes measurement data from the training data log 540 at the UE 115-a) on high priority SRBs may be relatively inefficient.

In some cases, after logging measurement information within the training data log 540, the UE 115-a may experience a link failure (e.g., a radio link failure (RLF)) or enter an idle state (e.g., an RRC idle state that pauses communications while remaining connected on a wireless communication link) before releasing (e.g., transmitting to another wireless device) the logged measurement information. In such cases, a RAN (e.g., a network entity 105 such as the network entity 105-a) connected to the UE 115-a may release the UE 115 context of the UE 115-a. Releasing UE 115 context may refer to a network entity 105 may deallocate memory and connection resources associated with the UE 115-a to free up memory and resources for other connections. In some cases, the network entity 105-a may release the UE 115 context of the UE 115-a after a RLF or after the UE 115-a enters an idle state as there may be a lack of on-going transfer of data on the respective wireless connection and keeping the connection may consume resources unnecessarily due to the lack of data transfer. Thus, to resume communications between the network entity 105-a and the UE 115-a, the UE 115-a may have to reestablish the UE 115 context with the network entity 105-a.

Therefore, in some aspects, since the configuration for the UE 115-a to report measurement information (e.g., training data) may be configured by the network (e.g., a network entity 105) and the reporting may be immediate, the UE 115-a may be unaware of which PLMNs or cells the UE 115-a is allowed to transmit the logged measurement information to. Moreover, in some cases, the UE 115-a may collect the measurement information based on a configuration from a first wireless vendor (e.g., a first infra-vendor). In such cases, the UE 115-a may be unaware of whether the UE 115-a can transmit the measurement information logged within the training data log 540 to a network entity 105 of a second wireless vendor (e.g., a second infra vendor). Thus, the UE 115-a may be unsure of where the UE 115-a is allowed to transmit measurement information that is logged within the training data log 540 after reestablishing communications with a network entity 105 (e.g., the network entity 105-a) from a RLF or being within an idle state.

In another aspect, for quality of experience (QoE) measurements, the UE 115-a may be capable of transmitting the measurement report 545 that includes measurement information over low priority SRBs such as SRB4 and SRB5 to reduce the overhead of high priority SRBs such as SRB1. However, when transmitting training data via QoE measurement reporting mechanisms, the UE 115-a may refrain from checking a PLMN before transmitting the measurement report 545. Such lack of verification may result in unauthorized data transmission from the UE 115-a. For example, users of UEs 115 may have to consent to training data collection that includes radio and positioning information and QoE reporting does not require user consent. Thus, if the UE 115-a uses QoE reporting mechanisms to transmit the measurement report 545 that includes measurement information related to model training data, the UE 115-a may transmit such training data without user consent. Further, similar to when transmitting over SRB1, there may be a lack of a request-based mechanism and the UE 115-a may be unaware of whether the UE 115-a can transmit the measurement information to a different wireless vendor than the wireless vendor associated with the training data collection configuration.

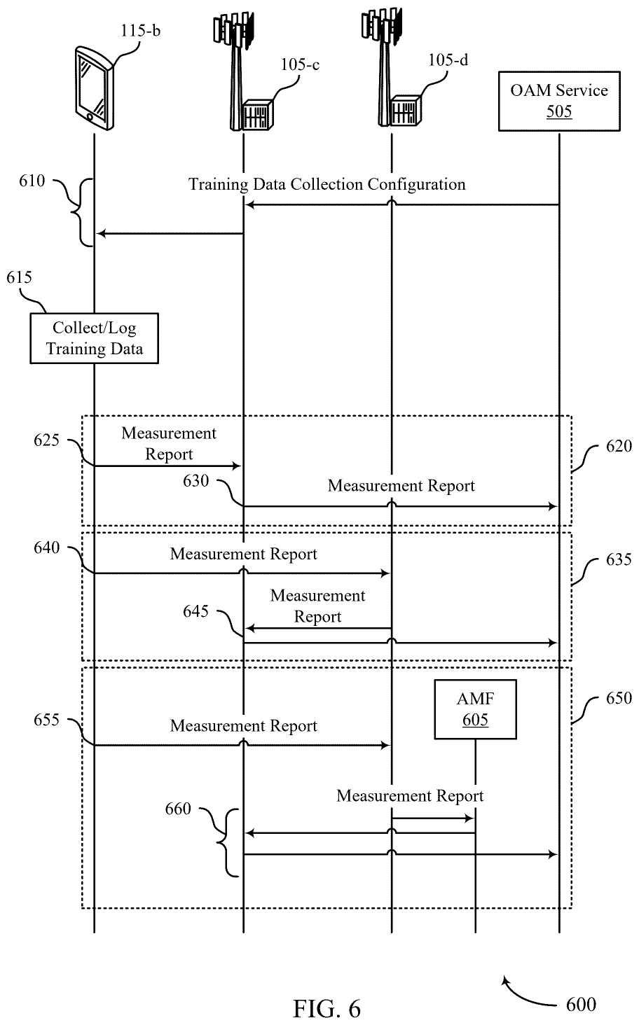

To prevent unauthorized transmission of data and to reduce high priority SRB overhead, the techniques of the present disclosure may provide one or more configuration enhancements, reporting enhancements, and inter-node signaling enhancements. For example, the techniques of the present disclosure may enable a network entity 105 (e.g., the network entity 105-a, the network entity 105-b, or the OAM service 505 via the network entity 105-a or the network entity 105-b) to transmit configuration information 550 to the UE 115-a to configure the UE 115-a with a measurement information (e.g., training data) collection and reporting configuration that includes information associated with PLMN identifiers, RAN notification area identifiers, tracking area codes, unique identifiers associated with training sessions or network entities for measurement reporting, and cell identifiers for where the UE 115-a is allowed to transmit the measurement information. Moreover, the configuration information 550 may also enable the UE 115-a to include the identity of the configuring network entity 105. In some examples, in accordance with the techniques of the present disclosure, the configuration information 550 may also enable the UE 115-a to transmit an availability indication to the network entity 105-a. The availability indication may indicate that the UE 115-a has measurement information that has been collected and logged and is ready to report. The network entity 105-a may, in response to receiving the availability indication, transmit a request for the measurement report and the UE 115-a may transmit the measurement report accordingly. Additionally, or alternatively, the techniques of the present disclosure may provide enhancements for network entities to report the measurement information (e.g., training data) from a retrieving node (e.g., the network entity 105-a) to a source node (e.g., the network entity 105-b, the OAM service 505, or both). Further descriptions of the techniques of the present disclosure may be described elsewhere herein, such as with reference to FIG. 6.

FIG. 6 shows an example of a process flow 600 that supports data collection and reporting configurations for network-based model training in accordance with one or more aspects of the present disclosure. In some examples, the process flow 600 may implement or be implemented by the wireless communications system 100, the wireless communications system 500, or both. For example, the process flow 600 may include a UE 115-b, a network entity 105-c, a network entity 105-d, an OAM service 505, and an AMF 605, which may be examples of devices described herein with reference to FIGS. 1 and 2.

In the following description of the process flow 600, the operations between the UE 115-b, the network entity 105-c, the network entity 105-d, the OAM service 505, and the AMF 605 may be performed in different orders or at different times. Some operations may also be left out of the process flow 600, or other operations may be added. Although the UE 115-b, the network entity 105-c, the network entity 105-d, the OAM service 505, and the AMF 605 are shown performing the operations of the process flow 600, some aspects of some operations may also be performed by one or more other wireless devices.

At 610, the UE 115-b (e.g., a first network entity) may receive configuration information configured to cause the UE 115-b to collect measurement information (e.g., training data) associated with network-based model training and to report a measurement report based on the measurement information. Further, the configuration may indicate one or more network identifiers that correspond to respective targets. For example, the network entity 105-c may configure the UE 115-b with a PLMN, a RAN notification area, a tracking area, cell list, or any combination thereof, of where the UE 115-b is allowed to transmit the measurement information via a measurement report. Moreover, the measurement report may include the measurement information. In some aspects, the one or more network identifiers may include mobile network identifiers (e.g., PLMN identifiers) that correspond to mobile networks (e.g., PLMNs) and the respective targets indicated in the configuration information may include the respective mobile networks. In some other aspects, the one or more network identifiers may include cell identifiers that correspond to respective cells (e.g., cell identifiers of cells that include network entities 105) and the respective targets may include the respective cells. In some aspects, a respective cell or network entity 105 (e.g., the network entity 105-c, the network entity 105-d, or both) may be within a respective RAN notification area, a respective tracking area, or both, and the network entity 105 may be associated with a same vendor. Thus, in some cases, the network entity may be capable of indicating the RAN notification area identifiers, tracking area code identifiers, or both within the one or more network identifiers indicated in the configuration information. Moreover, in some aspects, due the quality of information, the configuration information may refrain from indicating further information beyond the RAN notification area identifiers and tracking area code identifiers when a network entity 105 or cell that is in a RAN notification area or a tacking area belongs to the same vendor to reduce the signaling overhead of the configuration information. In some aspects, the configuration information may also indicate one or more identifiers (e.g., associated identifiers) for data collections for the network-based model training and the measurement information may be based on the one or more identifiers for the data collections. For example, the associated identifiers may indicate a which type of network data collection the network entity 105-c is requesting from the UE 115-b. In some cases, the one or more identifiers for the data collections may also indicate at least on a network entity 105 configuration, a codebook index, an antenna tilt, or any combination thereof. Additionally, or alternatively, the configuration information from the network entity 105-c, the network entity 105-d, or both, may configure the UE 115-b with a unique identifier or a group of identifiers. In some cases, the unique identifier or group of identifiers may indicate one or more measurement information collection sessions. In some other cases, the unique identifier or group of identifiers may indicate one or more network entities 105 where the respective targets may include the one or more network entities 105. Thus, the unique identifier or group of identifiers may configure the UE 115-b to identify a session of training data collection and one or more network identifiers 105. For example, the network entity 105-c may broadcast the configuration information and the configuration may include a unique identifier associated with the network entity 105-c. Therefore, if a network entity 105 connected to the UE 115-b to broadcasts at least one identifier that was broadcasted by the configuring network entity 105 (e.g., the network entity 105-c, the network entity 105-d, or both), the UE 115-b may be capable of transmitting data to the respective network entity 105.

In some cases, the network entity 105-d may receive the configuration information from the OAM service 505 via a training data collection configuration and forward the configuration to the network entity 105-c to be transmitted to the UE 115-b. In some cases, since the network entity 105-d may receive the configuration information from the OAM service 505, the network entity 105-d may be referred to as a retrieving network entity 105. Further, in some aspects, the network entity 105-c may correspond to a first PLMN of a first vendor (e.g., wireless vendor) and the network entity 105-d may correspond to first PLMN of the first vendor, a second PLMN of the first vendor, a first PLMN of a second vendor, and a second PLMN of the second vendor, or any combination thereof. Additionally, or alternatively, the network entity 105-c and the network entity 105-d may be co-located within a single network entity 105 or may be separate network entities 105 as illustrated herein.

Moreover, in some aspects, the OAM service 505 or a configuring network entity 105 may provide a list of cells for reporting in an L3 measurement report or in an immediate MDT configuration to avoid the UE 115-b reporting training data to non-authorized wireless vendors (e.g., infra-vendors), PLMNs, RAN notification areas, tracking area codes, or any combination thereof. Additionally, or alternatively, the UE 115-b may store the one or more network identifiers within the memory of the UE 115-b. For example, the UE 115-b may store the PLMN identifiers that are indicated via a transmission by a configuring cell in a SIB 1. Moreover, the UE 115-b may store such information within UE 115 variable storage. Thus, if a registered PLMN (RPLMN) is within the stored PLMN list at the UE 115-b, the UE 115-b may be capable of data to the cell associated with the RPLMN. In some aspects, for reporting to specific cells or cell groups, the network entity 105-c, the network entity 105-d, or both, may configure the UE 115-b with cell identifiers or unique identifiers of the respective cells or cell groups. In some other aspects, the UE 115-b may perform RAN notification area or tracking area based reporting, thus, the network entity 105-c, the network entity 105-d, or both, may configure the UE 115-b with RAN notification area identifiers, tracking area code identifiers, or both. Thus, at 615, in accordance with the configuration information received at 610, the UE 115-b may collect and log (e.g., store) measurement data for a measurement report. In some cases, prior to collecting the measurement information associated with the network-based model training, the UE 115-b may receive a request to collect the measurement information and the UE 115-b may collect the measurement information. In some aspects, the UE 115-b may accept the request based on the request including a data collection identifier that is included in the data collection identifiers configured at the UE 115-b via the received configuration information. Additionally, or alternatively, a serving network entity 105 (e.g., the network entity 105 connected to the UE 115-b) may perform an area check for the transmitting the configuration information, for the UE 115-b to perform measurement information collections, or both.

Prior to transmitting a measurement report that includes the measurement information collected and logged at 615, the UE 115-b may transmit an availability indication to the network (e.g., to one or more respective network entities 105). For example, the UE 115-b may transmit an availability indication to the respective targets indicated in the configuration information. The availability indication may indicate to the respective targets that measurements associated with the network-based model training are available for transmission at the UE 115-b. In some examples, the UE 115-b may transmit the availability indication to the respective targets based on an inclusion of the one or more network identifiers associated with the respective targets in the configuration information. In some cases, the UE 115-b may also include a quantity of logged data and an indication of the received configuration information within the availability indication.

In some implementations, after transmission of the availability indication, the UE 115-b may receive a request for a measurement report from a first target (e.g., a respective network entity 105) of the respective targets via a particular SRB of one or more SRBs. For example, the UE 115-b may transmit the availability indication to a respective target using an existing low priority SRB (e.g., SRB4 or SRB5) or another low priority SRB that is enumerated (e.g., numbered) as SRB4 or higher. Additionally, or alternatively, prior to transmission of the availability indication, the UE 115-b may verify that a respective target corresponds to a respective network identifier of the one or more network identifiers indicated in the configuration information. Thus, the UE 115-b may transmit the availability indication to the respective target based on the verification of the respective target. For example, the UE 115-b may check the list of PLMN identifiers, cell identifiers, unique identifiers, or any combination thereof included in the configuration information received at 610 prior to transmitting the availability indicator.

Once configured with the configuration information, the UE 115-b may transmit the measurement report to the respective targets that correspond to the one or more network identifiers indication within the configuration information. The UE 115-b may transmit the measurement report to the respective targets based on respective network identifiers associated with the respective targets being included in the configuration information. For example, for Uu link enhancements 620 (e.g., enhancements on an over-the-air communication link between a UE 115 and a network entity 105), at 625, the UE 115-b may transmit the measurement report to the network entity 105-c. In some aspects, the UE 115-b may transmit the measurement report to the network entity 105-c based on a network identifier associated with the network entity 105-c corresponding to a respective network identifier of the one or more network identifiers indicated in the configuration information received by the UE 115-b. In some cases, for the Uu link enhancements 620, at 630, the network entity 105-c may forward the measurement report to the OAM service 505. For example, the OAM service 505 may utilize the measurement information (e.g., the training data) collected by the UE 115-b to aid the network entity 105-c, the network entity 105-d, or both in training AI/ML models to improve communications between the UEs 115 and network entities 105 over the Uu link interface.

In another example, for Xn link enhancements 635, at 640, the UE 115-b may transmit the measurement report to the network entity 105-d. At 645, the network entity 105-d may forward the measurement information included in the measurement report to the network entity 105-c which may then forward the measurement information to the OAM service 505. Moreover, for next generation (NG)-application protocol link enhancements (e.g., NG-AP link enhancements 650), at 655, the UE 115-b may transmit the measurement report to the network entity 105-d. At 660, the network entity 105-d may then forward the measurement information included in the measurement report to the AMF 605. After receiving the measurement information, the AMF 605 may then forward the measurement information to the network entity 105-c and the network entity 105-c may forward the measurement information to the OAM service 505. In such cases, for the Xn link enhancements 635, the NG-AP link enhancements 650, or both, the network entity 105-c, based on receiving the measurement report, the network entity 105-d, or both may update one or more communication parameters associated with a wireless communication link between the network entity 105-c and the network entity 105-d. Therefore, the Xn interfaces, NG-AP interfaces may be enhanced for forwarding of the measurement information (e.g., training data) from the network entity 105-c (e.g., a configuring network entity) to the network entity 105-d (e.g., a receiving/retrieving network entity), and vice versa.

In some cases, the UE 115-b may transmit the measurement report at 625, 640, and 655, to the respective targets (e.g., the network entity 105-c, the network entity 105-d, or both) based on an indication of one or more measurement information collection sessions in the configuration information received at 610. In some other cases, the UE 115-b may transmit the measurement report to the respective targets based on the configuration information including an indication of one or more network entities where the respective targets may include the one or more network entities. For example, the configuration information may include an indication of the network entity 105-c, the network entity 105-d, or both and the UE 115-b may transmit the measurement report to the respective network entities 105 being indicated in the configuration information. Further, the UE 115-b may transmit the measurement report to the respective targets via a low priority SRB where the low priority SRB is enumerated as SRB4 or higher.

Additionally, or alternatively, the UE 115-b may transmit the measurement report to a respective target (e.g., a first target) via a respective SRB (e.g., a low priority SRB) based on receiving a request from the respective target. Moreover, the UE 115-b may use a QoE push-mechanism for reporting the measurement information, as described elsewhere herein. In some cases, in response to receiving the request from the first target (e.g., the network entity 105-c, the network entity 105-d, or both) and prior to transmitting the measurement report, the UE 115-b may verify the network identifier of the first target. For example, the UE 115-b may verify the first target corresponds to a respective network identifier of the one or more network identifiers indicated in the configuration information. Further, the UE 115-b may transmit the measurement report to the first target based on verifying the first target. Thus, the UE 115-b may check the list of PLMN identifiers, cell identifiers, unique identifiers indicated in the configuration information before transmitting the measurement report.

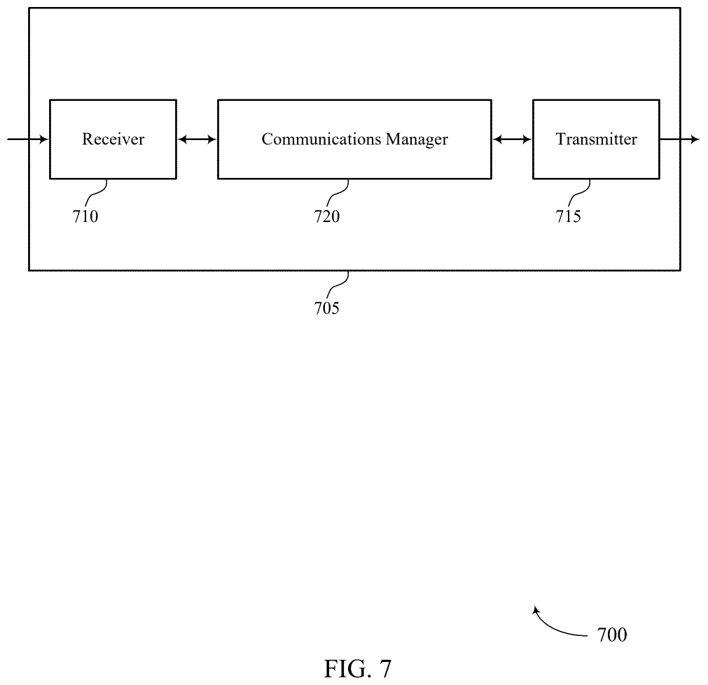

In some aspects, the measurement report may also include a configuring network identifier that is associated with a data collection configuration, an identifier associated with a data collection session for training that is associated with the data collection configuration, and one or more other identifiers that are associated with the data collection configuration. In some other aspects, the measurement report may also include a configuring network identifier that is associated with a network entity configuration, an identifier associated with a data collection session for training that is associated with the network entity configuration, and one or more other identifiers that are associated with the network entity configuration. For example, the UE 115-b may include identifiers of configuring network entities 105 or cells, an indication of one or more tracking area codes (TACs), or both. In another example, the UE 115-b may also include an indication of a PLMN identifier of a configuring network entity 105 to support the UE 115-b forwarding data to the configuring network entity 105. Additionally, or alternatively, the UE 115-b may include unique identifiers to indicate training data collection sessions, associated identifiers for logging training data, or both. Further descriptions of the techniques of the present disclosure to improve the reporting of measurement information (e.g., training data) by the UE 115-b may be described elsewhere herein, such as with reference to FIGS. 7 through 16.

FIG. 7 shows a block diagram 700 of a device 705 that supports data collection and reporting configurations for network-based model training in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to data collection and reporting configurations for network-based model training). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to data collection and reporting configurations for network-based model training). In some aspects, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of data collection and reporting configurations for network-based model training as described herein. For example, the communications manager 720, the receiver 710, the transmitter 715, or various combinations or components thereof may be capable of performing one or more of the functions described herein.

In some aspects, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information. The communications manager 720 is capable of, configured to, or operable to support a means for transmitting the measurement report to the respective targets that correspond to the one or more network identifiers indicated within the configuration information, where transmission of the measurement report to the respective targets is based on inclusion of respective network identifiers associated with the respective targets in the configuration information.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for a UE to improve the transfer of collected training data, provide configuration enhancements, provide reporting mechanism enhancements, and provide inter-node signaling enhancements to support reduced processing, reduced power consumption, and more efficient utilization of communication resources.

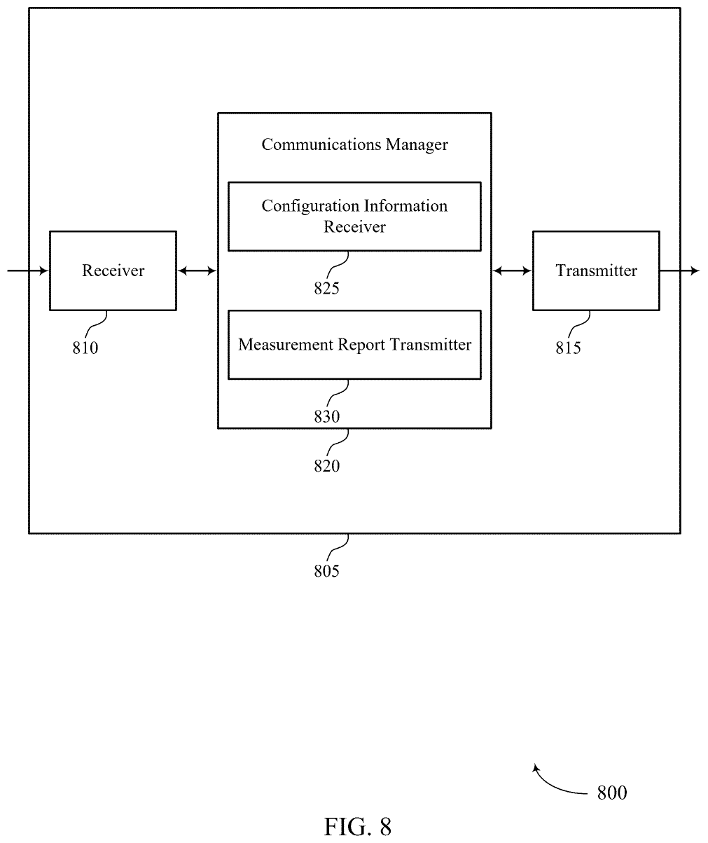

FIG. 8 shows a block diagram 800 of a device 805 that supports data collection and reporting configurations for network-based model training in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to data collection and reporting configurations for network-based model training). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to data collection and reporting configurations for network-based model training). In some aspects, the transmitter 815 may be co-located with a receiver 810 in a transceiver module. The transmitter 815 may utilize a single antenna or a set of multiple antennas.

The device 805, or various components thereof, may be an example of means for performing various aspects of data collection and reporting configurations for network-based model training as described herein. For example, the communications manager 820 may include a configuration information receiver 825 a measurement report transmitter 830, or any combination thereof. The communications manager 820 may be an example of aspects of a communications manager 720 as described herein. In some aspects, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration information receiver 825 is capable of, configured to, or operable to support a means for receiving configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information. The measurement report transmitter 830 is capable of, configured to, or operable to support a means for transmitting the measurement report to the respective targets that correspond to the one or more network identifiers indicated within the configuration information, where transmission of the measurement report to the respective targets is based on inclusion of respective network identifiers associated with the respective targets in the configuration information.

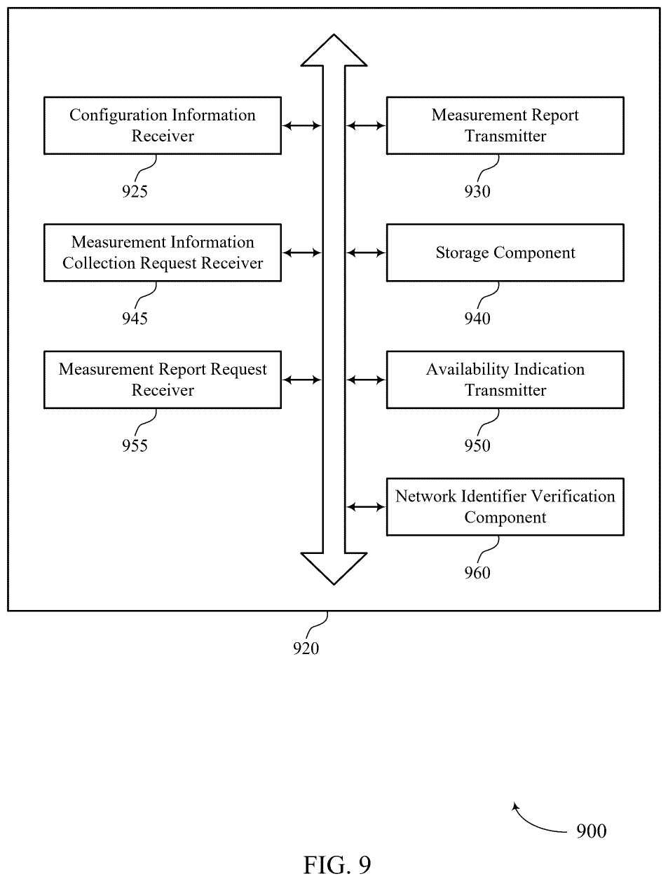

FIG. 9 shows a block diagram 900 of a communications manager 920 that supports data collection and reporting configurations for network-based model training in accordance with one or more aspects of the present disclosure. The communications manager 920 may be an example of aspects of a communications manager 720, a communications manager 820, or both, as described herein. The communications manager 920, or various components thereof, may be an example of means for performing various aspects of data collection and reporting configurations for network-based model training as described herein. For example, the communications manager 920 may include a configuration information receiver 925, a measurement report transmitter 930, a storage component 940, a measurement information collection request receiver 945, an availability indication transmitter 950, a measurement report request receiver 955, a network identifier verification component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration information receiver 925 is capable of, configured to, or operable to support a means for receiving configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information. The measurement report transmitter 930 is capable of, configured to, or operable to support a means for transmitting the measurement report to the respective targets that correspond to the one or more network identifiers indicated within the configuration information, where transmission of the measurement report to the respective targets is based on inclusion of respective network identifiers associated with the respective targets in the configuration information.

In some aspects, where the one or more network identifiers include mobile network identifiers that correspond to respective mobile networks. In some aspects, where the respective targets include the respective mobile networks.

In some aspects, where the one or more network identifiers include cell identifiers that correspond to respective cells. In some aspects, where the respective targets include the respective cells.

In some aspects, where the configuration information indicates one or more identifiers for data collections for the network-based model training, and where the measurement information is based on the one or more identifiers for the data collections.

In some aspects, where the one or more identifiers for the data collections indicate at least one of a network entity configuration, a codebook index, an antenna tilt, or any combination thereof.

In some aspects, the measurement information collection request receiver 945 is capable of, configured to, or operable to support a means for receiving a request to collect the measurement information associated with the network-based model training based on inclusion of a respective identifier for the data collections in the configuration information.

In some aspects, to support transmitting the measurement report, the measurement report transmitter 930 is capable of, configured to, or operable to support a means for transmitting the measurement report to the respective targets based on an indication of one or more measurement information collection sessions in the configuration information.

In some aspects, to support transmitting the measurement report, the measurement report transmitter 930 is capable of, configured to, or operable to support a means for transmitting the measurement report to the respective targets based on an indication of one or more network entities in the configuration information, where the respective targets include the one or more network entities.

In some aspects, the first network entity includes a memory accessible by a processing system, and the storage component 940 is capable of, configured to, or operable to support a means for storing the one or more network identifiers on the memory.

In some aspects, to support transmitting the measurement report, the measurement report transmitter 930 is capable of, configured to, or operable to support a means for transmitting the measurement report to the respective targets via a low priority signaling radio bearer (SRB), where the low priority SRB is enumerated as SRB4 or higher.

In some aspects, the availability indication transmitter 950 is capable of, configured to, or operable to support a means for transmitting, to the respective targets, an availability indication that indicates that measurements associated with the network-based model training are available for transmission, where transmission of the availability indication to the respective targets is based on inclusion of the one or more network identifiers associated with the respective targets in the configuration information. In some aspects, the measurement report request receiver 955 is capable of, configured to, or operable to support a means for receiving, from a first target of the respective targets via a particular SRB of one or more SRBs, a request for the measurement report, where transmission of the measurement report to the first target via respective is based on reception of the request.

In some aspects, the network identifier verification component 960 is capable of, configured to, or operable to support a means for verifying, in response to reception of the request from the first target and prior to transmission of the measurement report, that the first target corresponds to a respective network identifier of the one or more network identifiers indicated in the configuration information, where transmission of the measurement report to the first target is based on a verification of the first target.

In some aspects, the network identifier verification component 960 is capable of, configured to, or operable to support a means for verifying, prior to transmission of the availability indication, that a respective target corresponds to a respective network identifier of the one or more network identifiers indicated in the configuration information, where transmission of the availability indication to the respective target is based on a verification of the respective target.

In some aspects, the measurement report includes a configuring network identifier associated with a data collection configuration, an identifier associated with data collection session for training that is associated with the data collection configuration, and one or more other identifiers that are associated with the data collection configuration.

In some aspects, the measurement report includes a configuring network identifier associated with a network entity configuration, an identifier associated with data collection session for training that is associated with the network entity configuration, and one or more other identifiers that are associated with the network entity configuration.

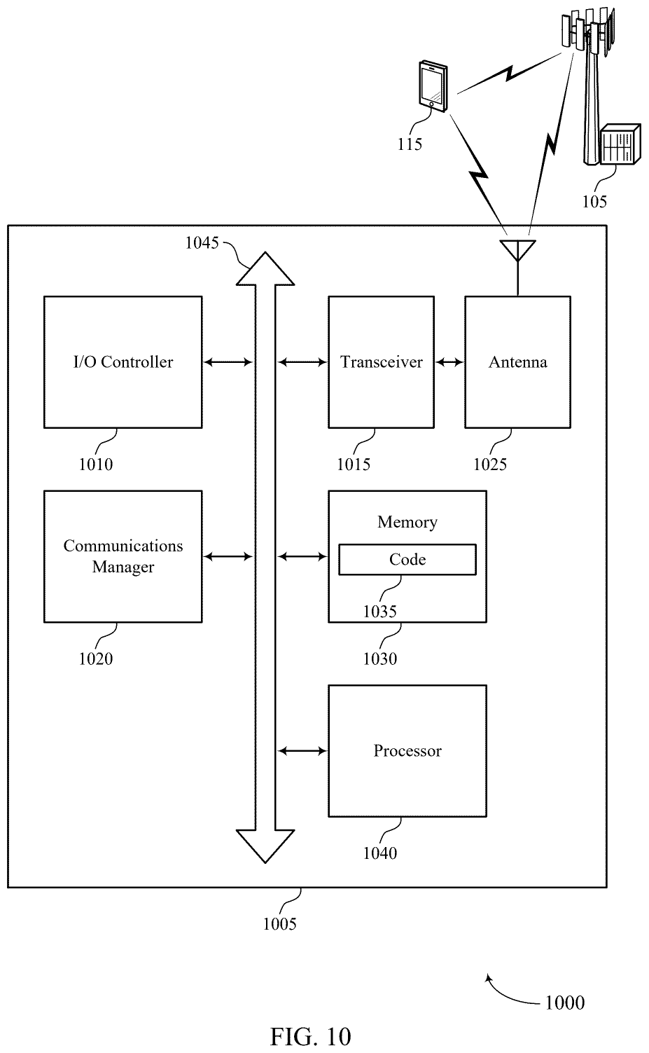

FIG. 10 shows a diagram of a system 1000 including a device 1005 that supports data collection and reporting configurations for network-based model training in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another operating systems. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting data collection and reporting configurations for network-based model training). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some aspects, the at least one processor 1040 may include multiple processors and the at least one memory 1030 may include multiple memories. One or more of the multiple processors may be coupled with one or more of the multiple memories, which may, individually or collectively, be configured to perform various functions described herein. In some aspects, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information. The communications manager 1020 is capable of, configured to, or operable to support a means for transmitting the measurement report to the respective targets that correspond to the one or more network identifiers indicated within the configuration information, where transmission of the measurement report to the respective targets is based on inclusion of respective network identifiers associated with the respective targets in the configuration information.

By including or configuring the communications manager 1020 in accordance with examples as described herein, the device 1005 may support techniques for a UE to improve the transfer of collected training data, provide configuration enhancements, provide reporting mechanism enhancements, and provide inter-node signaling enhancements to support improved communication reliability, reduced latency, improved user experience related to reduced processing, reduced power consumption, more efficient utilization of communication resources, improved coordination between devices, longer battery life, and improved utilization of processing capability.

In some aspects, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some aspects, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of data collection and reporting configurations for network-based model training as described herein, or the at least one processor 1040 and the at least one memory 1030 may be otherwise configured to, individually or collectively, perform or support such operations.

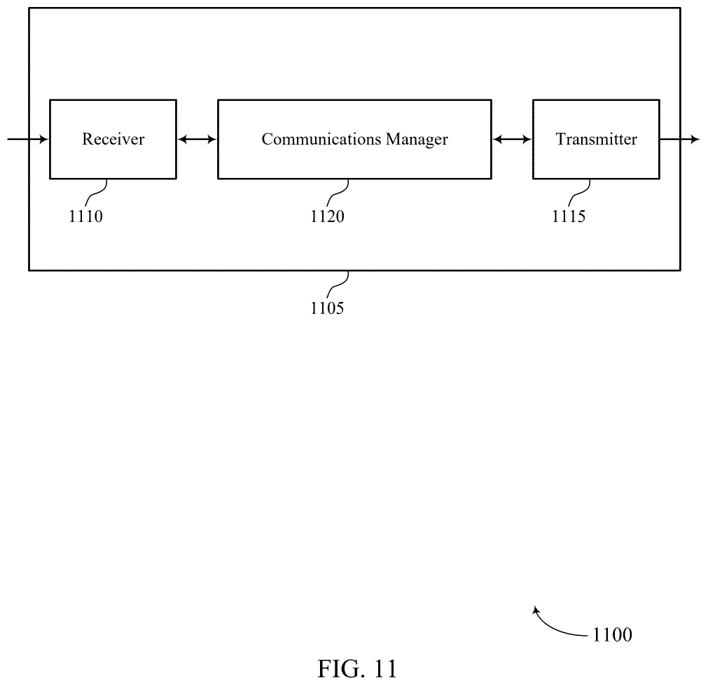

FIG. 11 shows a block diagram 1100 of a device 1105 that supports data collection and reporting configurations for network-based model training in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some aspects, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some aspects, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of data collection and reporting configurations for network-based model training as described herein. For example, the communications manager 1120, the receiver 1110, the transmitter 1115, or various combinations or components thereof may be capable of performing one or more of the functions described herein.

In some aspects, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information. The communications manager 1120 is capable of, configured to, or operable to support a means for receiving, from the second network entity, the measurement report, where reception of the measurement report by the first network entity is based on inclusion of a respective network identifier associated with the first network entity in the configuration information.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof)) may support techniques for a UE to improve the transfer of collected training data, provide configuration enhancements, provide reporting mechanism enhancements, and provide inter-node signaling enhancements to support reduced processing, reduced power consumption, and more efficient utilization of communication resources.

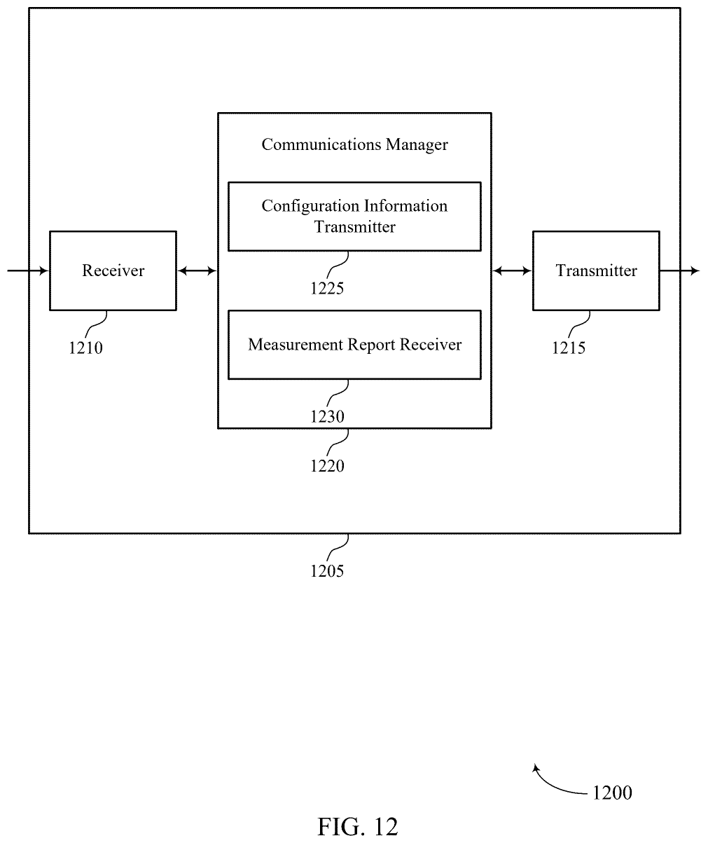

FIG. 12 shows a block diagram 1200 of a device 1205 that supports data collection and reporting configurations for network-based model training in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some aspects, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some aspects, the transmitter 1215 and the receiver 1210 may be co-located in a transceiver, which may include or be coupled with a modem.

The device 1205, or various components thereof, may be an example of means for performing various aspects of data collection and reporting configurations for network-based model training as described herein. For example, the communications manager 1220 may include a configuration information transmitter 1225 a measurement report receiver 1230, or any combination thereof. The communications manager 1220 may be an example of aspects of a communications manager 1120 as described herein. In some aspects, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration information transmitter 1225 is capable of, configured to, or operable to support a means for transmitting configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information. The measurement report receiver 1230 is capable of, configured to, or operable to support a means for receiving, from the second network entity, the measurement report, where reception of the measurement report by the first network entity is based on inclusion of a respective network identifier associated with the first network entity in the configuration information.

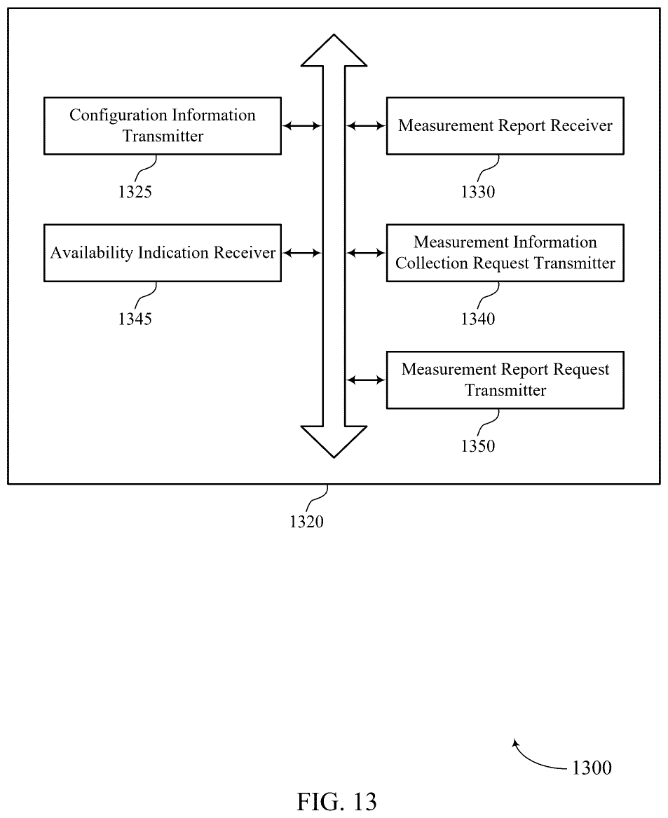

FIG. 13 shows a block diagram 1300 of a communications manager 1320 that supports data collection and reporting configurations for network-based model training in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of data collection and reporting configurations for network-based model training as described herein. For example, the communications manager 1320 may include a configuration information transmitter 1325, a measurement report receiver 1330, a measurement information collection request transmitter 1340, an availability indication receiver 1345, a measurement report request transmitter 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration information transmitter 1325 is capable of, configured to, or operable to support a means for transmitting configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information. The measurement report receiver 1330 is capable of, configured to, or operable to support a means for receiving, from the second network entity, the measurement report, where reception of the measurement report by the first network entity is based on inclusion of a respective network identifier associated with the first network entity in the configuration information.

In some aspects, where the one or more network identifiers include mobile network identifiers that correspond to respective mobile networks. In some aspects, where the respective targets include the respective mobile networks.

In some aspects, where the one or more network identifiers include cell identifiers that correspond to respective cells. In some aspects, where the respective targets include the respective cells.

In some aspects, where the configuration information indicates one or more identifiers for data collections for the network-based model training, and where the measurement information is based on the one or more identifiers for the data collections.

In some aspects, where the one or more identifiers for the data collections indicate at least one of a network entity configuration, a codebook index, an antenna tilt, or any combination thereof.

In some aspects, the measurement information collection request transmitter 1340 is capable of, configured to, or operable to support a means for transmitting, to the second network entity, a request to collect the measurement information associated with the network-based model training based on inclusion of a respective identifier for the data collections in the configuration information.

In some aspects, to support receiving the measurement report, the measurement report receiver 1330 is capable of, configured to, or operable to support a means for receiving, from the second network entity, the measurement report based on an indication of one or more measurement information collection sessions in the configuration information.

In some aspects, to support receiving the measurement report, the measurement report receiver 1330 is capable of, configured to, or operable to support a means for receiving, from the second network entity, the measurement report based on an indication of one or more network entities in the configuration information, where the respective targets include the one or more network entities, and where the one or more network entities includes the first network entity.

In some aspects, to support receiving the measurement report, the measurement report receiver 1330 is capable of, configured to, or operable to support a means for receiving, from the second network entity, the measurement report via a low priority signaling radio bearer (SRB), where the low priority SRB is enumerated as SRB4 or higher.

In some aspects, the availability indication receiver 1345 is capable of, configured to, or operable to support a means for receiving, from the second network entity, an availability indication that indicates that measurements associated with the network-based model training are available for transmission, where reception of the availability indication at the first network entity is based on inclusion of the one or more network identifiers associated with first network entity in the configuration information. In some aspects, the measurement report request transmitter 1350 is capable of, configured to, or operable to support a means for transmitting, to the second network entity via a particular SRB of one or more SRBs, a request for the measurement report, where reception of the measurement report from the second network entity via respective is based on reception of the request.

In some aspects, the measurement report includes a configuring network identifier associated with a data collection configuration, an identifier associated with data collection session for training that is associated with the data collection configuration, and one or more other identifiers that are associated with the data collection configuration.

In some aspects, the measurement report includes a configuring network identifier associated with a network entity configuration, an identifier associated with data collection session for training that is associated with the network entity configuration, and one or more other identifiers that are associated with the network entity configuration.

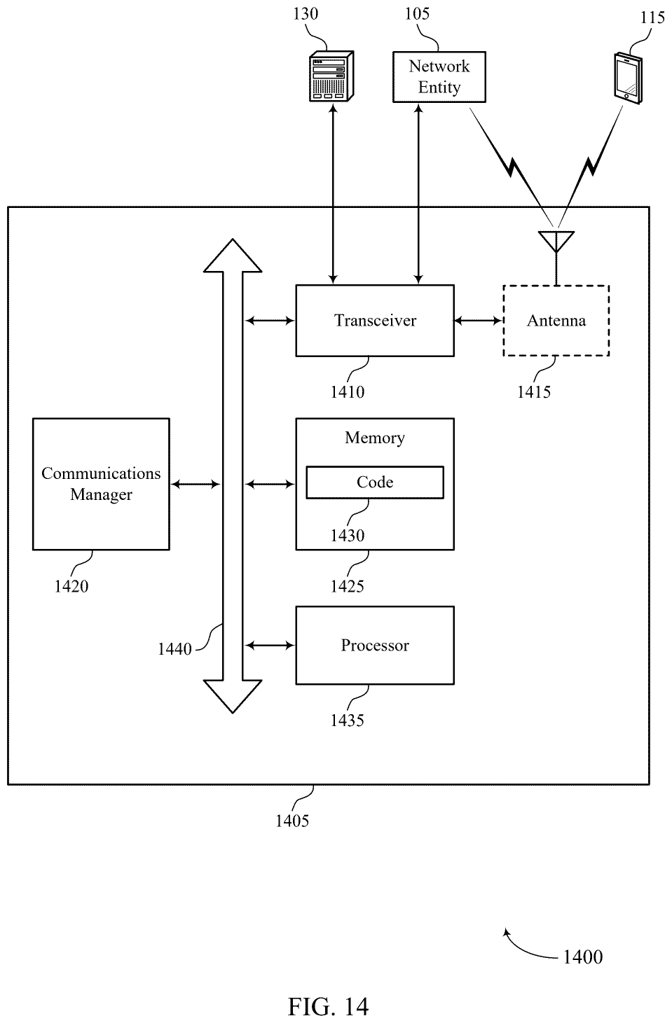

FIG. 14 shows a diagram of a system 1400 including a device 1405 that supports data collection and reporting configurations for network-based model training in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some aspects, the transceiver 1410 may include a wired transceiver and may communicate bi-directionally with another wired transceiver. Additionally, or alternatively, in some aspects, the transceiver 1410 may include a wireless transceiver and may communicate bi-directionally with another wireless transceiver. In some aspects, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some aspects, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some aspects, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting data collection and reporting configurations for network-based model training). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some aspects, the at least one processor 1435 may include multiple processors and the at least one memory 1425 may include multiple memories. One or more of the multiple processors may be coupled with one or more of the multiple memories, which may, individually or collectively, be configured to perform various functions herein. In some aspects, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some aspects, a bus 1440 may support communications of (e.g., within) a protocol layer of a protocol stack. In some aspects, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some aspects, the communications manager 1420 may manage aspects of communications with a core network 130 (e.g., via one or more wired or wireless backhaul links). For example, the communications manager 1420 may manage the transfer of data communications for client devices, such as one or more UEs 115. In some aspects, the communications manager 1420 may manage communications with one or more other network entities 105, and may include a controller or scheduler for controlling communications with UEs 115 (e.g., in cooperation with the one or more other network devices). In some aspects, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information. The communications manager 1420 is capable of, configured to, or operable to support a means for receiving, from the second network entity, the measurement report, where reception of the measurement report by the first network entity is based on inclusion of a respective network identifier associated with the first network entity in the configuration information.

By including or configuring the communications manager 1420 in accordance with examples as described herein, the device 1405) may support techniques for a UE to improve the transfer of collected training data, provide configuration enhancements, provide reporting mechanism enhancements, and provide inter-node signaling enhancements to support improved communication reliability, reduced latency, improved user experience related to reduced processing, reduced power consumption, more efficient utilization of communication resources, improved coordination between devices, longer battery life, and improved utilization of processing capability.

In some aspects, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some aspects, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of data collection and reporting configurations for network-based model training as described herein, or the at least one processor 1435 and the at least one memory 1425 may be otherwise configured to, individually or collectively, perform or support such operations.

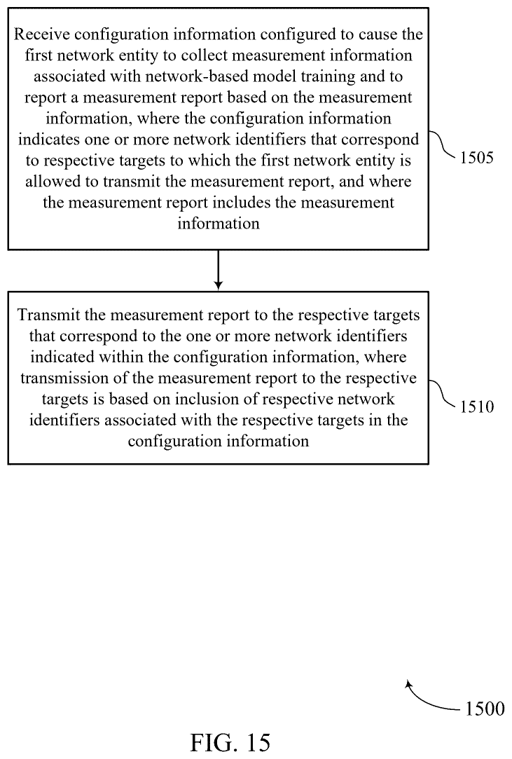

FIG. 15 shows a flowchart illustrating a method 1500 that supports data collection and reporting configurations for network-based model training in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some aspects, a UE may execute a set of instructions to control the functional elements of the UE to perform the described functions. Additionally, or alternatively, the UE may perform aspects of the described functions using special-purpose hardware.

At 1505, the method may include receiving configuration information configured to cause the first network entity to collect measurement information associated with network-based model training and to report a measurement report based on the measurement information, where the configuration information indicates one or more network identifiers that correspond to respective targets to which the first network entity is allowed to transmit the measurement report, and where the measurement report includes the measurement information. The operations of 1505 may be performed in accordance with examples as disclosed herein. In some examples, aspects of the operations of 1505 may be performed by a configuration information receiver 925 as described with reference to FIG. 9.

At 1510, the method may include transmitting the measurement report to the respective targets that correspond to the one or more network identifiers indicated within the configuration information, where transmission of the measurement report to the respective targets is based on inclusion of respective network identifiers associated with the respective targets in the configuration information. The operations of 1510 may be performed in accordance with examples as disclosed herein. In some examples, aspects of the operations of 1510 may be performed by a measurement report transmitter 930 as described with reference to FIG. 9.

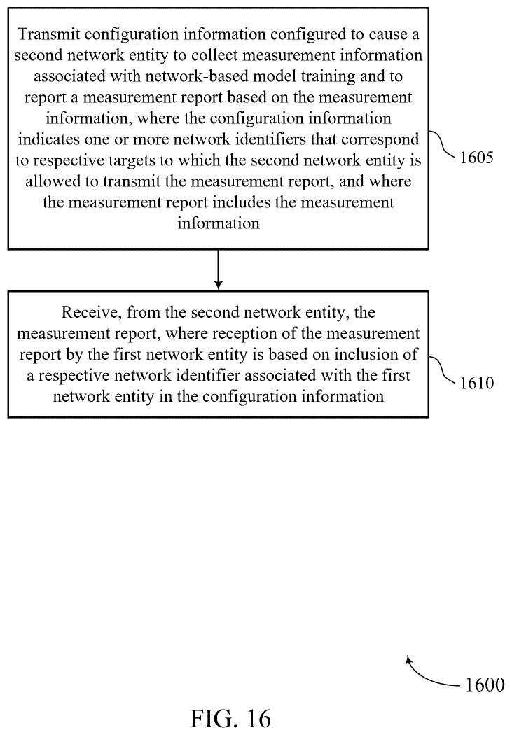

FIG. 16 shows a flowchart illustrating a method 1600 that supports data collection and reporting configurations for network-based model training in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some aspects, a network entity may execute a set of instructions to control the functional elements of the network entity to perform the described functions. Additionally, or alternatively, the network entity may perform aspects of the described functions using special-purpose hardware.

At 1605, the method may include transmitting configuration information configured to cause a second network entity to collect measurement information associated with network-based model training and to report a measurement report based on the measurement information, where the configuration information indicates one or more network identifiers that correspond to respective targets to which the second network entity is allowed to transmit the measurement report, and where the measurement report includes the measurement information. The operations of 1605 may be performed in accordance with examples as disclosed herein. In some examples, aspects of the operations of 1605 may be performed by a configuration information transmitter 1325 as described with reference to FIG. 13.

At 1610, the method may include receiving, from the second network entity, the measurement report, where reception of the measurement report by the first network entity is based on inclusion of a respective network identifier associated with the first network entity in the configuration information. The operations of 1610 may be performed in accordance with examples as disclosed herein. In some examples, aspects of the operations of 1610 may be performed by a measurement report receiver 1330 as described with reference to FIG. 13.

The following provides an overview of aspects of the present disclosure:

Aspect 1: A method for wireless communications by a first network entity, comprising: receiving configuration information configured to cause the first network entity to collect measurement information associated with network-based model training and to report a measurement report based on the measurement information, wherein the configuration information indicates one or more network identifiers that correspond to respective targets to which the first network entity is allowed to transmit the measurement report, and wherein the measurement report includes the measurement information; and transmitting the measurement report to the respective targets that correspond to the one or more network identifiers indicated within the configuration information, wherein transmission of the measurement report to the respective targets is based on inclusion of respective network identifiers associated with the respective targets in the configuration information.

Aspect 2: The method of aspect 1, wherein the one or more network identifiers include mobile network identifiers that correspond to respective mobile networks; and wherein the respective targets include the respective mobile networks

Aspect 3: The method of any of aspects 1 through 2, wherein the one or more network identifiers include cell identifiers that correspond to respective cells; and wherein the respective targets include the respective cells

Aspect 4: The method of any of aspects 1 through 3, wherein the configuration information indicates one or more identifiers for data collections for the network-based model training, and wherein the measurement information is based on the one or more identifiers for the data collections

Aspect 5: The method of aspect 4, wherein the one or more identifiers for the data collections indicate at least one of a network entity configuration, a codebook index, an antenna tilt, or any combination thereof

Aspect 6: The method of any of aspects 4 through 5, further comprising: receiving a request to collect the measurement information associated with the network-based model training based on inclusion of a respective identifier for the data collections in the configuration information.

Aspect 7: The method of any of aspects 1 through 6, wherein transmitting the measurement report comprises: transmitting the measurement report to the respective targets based on an indication of one or more measurement information collection sessions in the configuration information.

Aspect 8: The method of any of aspects 1 through 7, wherein transmitting the measurement report comprises: transmitting the measurement report to the respective targets based on an indication of one or more network entities in the configuration information, wherein the respective targets include the one or more network entities.

Aspect 9: The method of any of aspects 1 through 8, wherein the first network entity comprises a memory accessible by a processing system, and the method further comprises: storing the one or more network identifiers on the memory.

Aspect 10: The method of any of aspects 1 through 9, wherein transmitting the measurement report comprises: transmitting the measurement report to the respective targets via a low priority SRB, wherein the low priority SRB is enumerated as SRB4 or higher.

Aspect 11: The method of aspect 10, further comprising: transmitting, to the respective targets, an availability indication that indicates that measurements associated with the network-based model training are available for transmission, wherein transmission of the availability indication to the respective targets is based on inclusion of the one or more network identifiers associated with the respective targets in the configuration information; and receiving, from a first target of the respective targets via a particular SRB of one or more SRBs, a request for the measurement report, wherein transmission of the measurement report to the first target via respective is based on reception of the request

Aspect 12: The method of aspect 11, further comprising: verifying, in response to reception of the request from the first target and prior to transmission of the measurement report, that the first target corresponds to a respective network identifier of the one or more network identifiers indicated in the configuration information, wherein transmission of the measurement report to the first target is based on a verification of the first target.

Aspect 13: The method of any of aspects 11 through 12, further comprising: verifying, prior to transmission of the availability indication, that a respective target corresponds to a respective network identifier of the one or more network identifiers indicated in the configuration information, wherein transmission of the availability indication to the respective target is based on a verification of the respective target.

Aspect 14: The method of any of aspects 1 through 13, wherein the measurement report includes a configuring network identifier associated with a data collection configuration, an identifier associated with data collection session for training that is associated with the data collection configuration, and one or more other identifiers that are associated with the data collection configuration.

Aspect 15: The method of any of aspects 1 through 14, wherein the measurement report includes a configuring network identifier associated with a network entity configuration, an identifier associated with data collection session for training that is associated with the network entity configuration, and one or more other identifiers that are associated with the network entity configuration.

Aspect 16: A method for wireless communications by a first network entity, comprising: transmitting configuration information configured to cause a second network entity to collect measurement information associated with network-based model training and to report a measurement report based on the measurement information, wherein the configuration information indicates one or more network identifiers that correspond to respective targets to which the second network entity is allowed to transmit the measurement report, and wherein the measurement report includes the measurement information; and receiving, from the second network entity, the measurement report, wherein reception of the measurement report by the first network entity is based on inclusion of a respective network identifier associated with the first network entity in the configuration information.

Aspect 17: The method of aspect 16, wherein the one or more network identifiers include mobile network identifiers that correspond to respective mobile networks; and wherein the respective targets include the respective mobile networks

Aspect 18: The method of any of aspects 16 through 17, wherein the one or more network identifiers include cell identifiers that correspond to respective cells; and wherein the respective targets include the respective cells

Aspect 19: The method of any of aspects 16 through 18, wherein the configuration information indicates one or more identifiers for data collections for the network-based model training, and wherein the measurement information is based on the one or more identifiers for the data collections

Aspect 20: The method of aspect 19, wherein the one or more identifiers for the data collections indicate at least one of a network entity configuration, a codebook index, an antenna tilt, or any combination thereof

Aspect 21: The method of any of aspects 19 through 20, further comprising: transmitting, to the second network entity, a request to collect the measurement information associated with the network-based model training based on inclusion of a respective identifier for the data collections in the configuration information.

Aspect 22: The method of any of aspects 16 through 21, wherein receiving the measurement report comprises: receiving, from the second network entity, the measurement report based on an indication of one or more measurement information collection sessions in the configuration information.

Aspect 23: The method of any of aspects 16 through 22, wherein receiving the measurement report comprises: receiving, from the second network entity, the measurement report based on an indication of one or more network entities in the configuration information, wherein the respective targets include the one or more network entities, and wherein the one or more network entities comprises the first network entity.

Aspect 24: The method of any of aspects 16 through 23, wherein receiving the measurement report comprises: receiving, from the second network entity, the measurement report via a low priority SRB, wherein the low priority SRB is enumerated as SRB4 or higher.

Aspect 25: The method of aspect 24, further comprising: receiving, from the second network entity, an availability indication that indicates that measurements associated with the network-based model training are available for transmission, wherein reception of the availability indication at the first network entity is based on inclusion of the one or more network identifiers associated with first network entity in the configuration information; and transmitting, to the second network entity via a particular SRB of one or more SRBs, a request for the measurement report, wherein reception of the measurement report from the second network entity via respective is based on reception of the request.

Aspect 26: The method of any of aspects 16 through 25, wherein the measurement report includes a configuring network identifier associated with a data collection configuration, an identifier associated with data collection session for training that is associated with the data collection configuration, and one or more other identifiers that are associated with the data collection configuration.

Aspect 27: The method of any of aspects 16 through 26, wherein the measurement report includes a configuring network identifier associated with a network entity configuration, an identifier associated with data collection session for training that is associated with the network entity configuration, and one or more other identifiers that are associated with the network entity configuration.

Aspect 28: A first network entity for wireless communications, comprising one or more memories storing processor-executable code, and one or more processors coupled with the one or more memories and individually or collectively operable to execute the code to cause the first network entity to perform a method of any of aspects 1 through 15.

Aspect 29: A first network entity for wireless communications, comprising at least one means for performing a method of any of aspects 1 through 15.

Aspect 30: A non-transitory computer-readable medium storing code for wireless communications, the code comprising instructions executable by one or more processors to perform a method of any of aspects 1 through 15.

Aspect 31: A first network entity for wireless communications, comprising one or more memories storing processor-executable code, and one or more processors coupled with the one or more memories and individually or collectively operable to execute the code to cause the first network entity to perform a method of any of aspects 16 through 27.

Aspect 32: A first network entity for wireless communications, comprising at least one means for performing a method of any of aspects 16 through 27.

Aspect 33: A non-transitory computer-readable medium storing code for wireless communications, the code comprising instructions executable by one or more processors to perform a method of any of aspects 16 through 27.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and the claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communications, comprising:
a processing system configured to:
receive configuration information configured to cause the first network entity to collect measurement information associated with network-based model training and to report a measurement report based on the measurement information, wherein the measurement report includes the measurement information;
transmit, to respective targets, an availability indication that indicates that the measurement information associated with the network-based model training is available at the first network entity for transmission; and
transmit the measurement report to the respective targets in accordance with the configuration information and based on the transmission of the availability indication.

2. The first network entity of claim 1, wherein, to transmit the measurement report, the processing system is configured to:
transmit the measurement report to the respective targets via a low priority signaling radio bearer (SRB), wherein the low priority SRB is enumerated as SRB4 or higher.

3. The first network entity of claim 2, wherein the processing system is configured to:
receive, from a first target of the respective targets via a particular SRB of one or more SRBs, a request for the measurement report, wherein the transmission of the measurement report to the first target via the particular SRB is based on reception of the request.

4. The first network entity of claim 3, wherein the processing system is configured to:
verify, in response to the reception of the request from the first target and prior to the transmission of the measurement report, that the first target corresponds to a respective network identifier of one or more network identifiers indicated in the configuration information, wherein the transmission of the measurement report to the first target is based on a verification of the first target.

5. The first network entity of claim 3, wherein the processing system is configured to:
verify, prior to the transmission of the availability indication, that a respective target corresponds to a respective network identifier of one or more network identifiers indicated in the configuration information, wherein the transmission of the availability indication to the respective target is based on a verification of the respective target.

6. The first network entity of claim 1, wherein the measurement report includes a configuring network identifier associated with a data collection configuration, an identifier associated with data collection session for training that is associated with the data collection configuration, and one or more other identifiers that are associated with the data collection configuration.

7. The first network entity of claim 1, wherein the measurement report includes a configuring network identifier associated with a network entity configuration, an identifier associated with data collection session for training that is associated with the network entity configuration, and one or more other identifiers that are associated with the network entity configuration.

8. The first network entity of claim 1,
wherein the configuration information indicates one or more identifiers for data collections for the network-based model training, and wherein the measurement information is based on the one or more identifiers for the data collections.

9. The first network entity of claim 8,
wherein the one or more identifiers for the data collections indicate at least one of a network entity configuration, a codebook index, an antenna tilt, or any combination thereof.

10. The first network entity of claim 8, further comprising:
receiving a request to collect the measurement information associated with the network-based model training based on inclusion of a respective identifier for the data collections in the configuration information.

11. The first network entity of claim 1, wherein, to transmit the measurement report, the processing system is configured to:
transmit the measurement report to the respective targets based on an indication of one or more measurement information collection sessions in the configuration information.

12. The first network entity of claim 1, wherein, to transmit the measurement report, the processing system is configured to:
transmit the measurement report to the respective targets based on an indication of one or more network entities in the configuration information, wherein the respective targets include the one or more network entities.

13. The first network entity of claim 1, wherein the first network entity comprises a memory accessible by the processing system, and wherein the processing system is configured to:
receive, via the configuration information, an indication of one or more network identifiers that correspond to the respective targets to which the first network entity is allowed to transmit the measurement report; and
store the one or more network identifiers on the memory.

14. The first network entity of claim 1,
wherein the configuration information indicates one or more network identifiers that correspond to the respective targets to which the first network entity is allowed to transmit the measurement report.

15. The first network entity of claim 14,
wherein the one or more network identifiers include mobile network identifiers that correspond to respective mobile networks; and
wherein the respective targets include the respective mobile networks.

16. The first network entity of claim 14,
wherein the one or more network identifiers include cell identifiers that correspond to respective cells; and
wherein the respective targets include the respective cells.

17. A first network entity for wireless communications, comprising:
a processing system configured to:
transmit configuration information configured to cause a second network entity to collect and report measurement information associated with network-based model training, wherein the configuration information indicates to report a measurement report that includes the measurement information;
receive, from the second network entity, an availability indication that indicates that measurement information association with the network-based model training is available at the second network entity for transmission; and
receive, from the second network entity, the measurement report in accordance with the configuration information and based on reception of the availability indication.

18. The first network entity of claim 17, wherein the processing system is configured to:
receive, from the second network entity, the measurement report via a low priority signaling radio bearer (SRB), wherein the low priority SRB is enumerated as SRB4 or higher.

19. The first network entity of claim 18, wherein the processing system is configured to:
receive, from the second network entity via the availability indication, an indication that one or more SRBs are available at the second network entity, wherein the reception of the availability indication is based on an association between at least one network identifier of one or more network identifiers indicated within the configuration information and the first network entity; and
transmit, to the second network entity via a respective SRB indicated as available in the availability indication, a request for the measurement report, wherein the measurement report is received via the respective SRB based on the transmission of the request.

20. A method of wireless communications performed by a first network entity, comprising:
receiving configuration information configured to cause the first network entity to collect measurement information associated with network-based model training and to report a measurement report based on the measurement information, wherein the measurement report includes the measurement information;
transmitting, to respective targets, an availability indication that indicates that the measurement information associated with the network-based model training is available at the first network entity for transmission; and
transmitting the measurement report to the respective targets in accordance with the configuration information and based on the transmission of the availability indication.
